(19) United States
(12) Patent Application Publication
(10) Pub. No.: US 2008/0184375 A1
(43) Pub. Date: Jul. 31, 2008

(54) Confidential data protection apparatus, autonomous mobile robot, confidential data protection method, computer program, and integrated circuit

(76) Inventors: Masao Nonaka, Osaka (JP); Natsume Matsuzaki, Osaka (JP); Kaoru Yokota, Hyogo (JP); Soichiro Fujioka, Osaka (JP); Yoshihiko Matsukawa, Nara (JP); Toshio Inaji, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/797,869

(22) Filed: May 8, 2007

(30) Foreign Application Priority Data
May 9, 2006 (JP) 2006-129995

(51) Int. Cl. H04L 9/32

(52) U.S. Cl. 726/27

(57) ABSTRACT

The confidential data protection apparatus that restricts use of confidential data to a particular place, thereby satisfying high security.

When the confidential data is encrypted, the image data acquisition unit 1004 captures an image in the particular place using a camera module, the place-specific code generation unit 1007 generates a place-specific code using data of the captured image, the encryption processing unit 1009 encrypts the confidential data using the place-specific code, which is deleted after use. When the confidential data is attempted to be used, the image data acquisition unit 1004 uses the camera module again to capture another image in a place where the confidential data is attempted to be used, and the place-specific code generation unit 1007 uses data of the newly captured image to generate a new place-specific code. The encryption processing unit 1009 uses the new place-specific code in an attempt to decrypt the confidential data that has been encrypted.

This application is based on an application No. 2006-129995 filed in Japan, the content of which is hereby incorporated by reference.

### BACKGROUND OF THE INVENTION

(1) Field of the Invention

The present invention relates to a confidential data protection apparatus for protecting confidential data.

(2) Description of the Related Art

In recent years, a leak of confidential data that is stored in a confidential data protection apparatus, such as a laptop computer, has been recognized as a social problem. A typical example is a case where a company use laptop computer that stores confidential data, which is related to business, is taken to the home of a company employee, and then, when connected to his/her home network, the laptop computer gets a virus, resulting in the confidential data leaking out of the laptop computer. Such situations cause companies to ruin their reputations.

One of the measures to prevent confidential data from leaking, as described above, provides a method in which a confidential data protection apparatus restricts places where confidential data is permitted to be used. Hereinafter, this method is referred to as a place bind of confidential data.

One example of techniques to realize the place bind is disclosed in Patent Document 1. According to Patent Document 1, a dynamic key to encrypt and decrypt confidential data is generated with use of GPS (Global Positioning System) information.

After being used, the confidential data is encrypted with use of the dynamic key. In the case of the confidential data being used after the encryption, the dynamic key is generated once again with use of GPS information in order to decrypt the confidential data herein after.

With the above-described technique, only when a user is in a place where the user can obtain the same GPS information as the information used at the time of encryption, the same dynamic key is generated, whereby the user can decrypt the encrypted confidential data correctly.

However, GPS information adopted in the technique in Patent Document 1 is information regarding a latitude and a longitude, which can be guessed to some extent without actually going to a pre-specified place. Therefore, the dynamic key that is generated based on the GPS information can also be guessed without actually going to the pre-specified place. As a result, the place bind realized by this technology has low security.

In order to solve the above-described problems, the object of the present invention is to provide a confidential data protection apparatus that performs a place bind for confidential data, the place bind having higher security than conventional place binds.

[Patent Document] Japanese laid-open patent application No. 2003-32243

### SUMMARY OF THE INVENTION

In order to solve the above-described problems, the present invention provides a confidential data protection apparatus that restricts use of confidential data to a particular place, the confidential data protection apparatus comprising: a storage unit that stores the confidential data; an image capturing unit operable to capture an image at a place to generate image data; a generation unit operable to generate a place-specific code with use of the generated image data, the place-specific code indicating a characteristic specific to the place at which the image capturing was performed; and a control unit operable to control whether or not to permit use of the confidential data, based on the place-specific code.

With the above-described structure, the confidential data protection apparatus of the present invention can cause a user to acquire a place-specific code, which is used to control whether or not to permit use of confidential data, only by actually going to the particular place. Also, it is possible to make it difficult to guess the place-specific code. Therefore, a place bind having higher security can be realized for confidential data.

Furthermore, the generation unit may include a detection sub-unit operable to divide the image into smaller pieces of image, and detect edges of picture objects shown therein; a coding sub-unit operable to allocate a code to each of the edges that have been detected; and a concatenating sub-unit operable to generate the place-specific code by concatenating each of the codes that have been allocated.

According to the above-described structure, since picture objects shown in the plurality of smaller pieces of image are only slightly different from each other, edges of the picture objects detected in the plurality of smaller pieces of image are identical. Therefore, it is possible to control whether or not to permit use of confidential data, in a manner that allows small changes in a captured image such as image blurring and noise. Specifically, in the case of an attempt to use the confidential data, when the user captures an image in the same place where the use of the confidential data has been disabled, the same code can be generated from each piece of the captured image data, which is data of the captured image, despite a certain degree of changes in the image-captured object.

Furthermore, the generation unit includes: a detection sub-unit operable to divide the image into smaller pieces of image, and detect color information indicating dominant colors shown in the smaller pieces of image; a coding sub-unit operable to allocate a code to each piece of the color information that is detected from a different one of the smaller pieces; and a concatenating sub-unit operable to generate the place-specific code by concatenating the codes that have been allocated.

According to the above-described structure, the dominant colors shown in the plurality of smaller pieces of image are the same since picture objects shown therein are only slightly different from each other. Accordingly, whether or not to permit use of confidential data can be controlled in such that allows small changes in a captured image such as image blurring and noise. Specifically, in the case of an attempt to permit the confidential data to be used, when the user captures an image of a scene in the same place as the place where the use of the confidential data has been disabled, the same code can be generated from each piece of the image data, despite a certain degree of changes in the image-captured object.

Furthermore, the generation unit extracts information indicating at least one of (i) a shape of an object, (ii) a color of the object, and (iii) a size of the object that are shown in the generated image data, and generates the place-specific code using the information that has been extracted.

According to the above-described structure, a place-specific code, which is used to control whether or not to permit use of confidential data, is generated by extracting at least one piece of information from among pieces of information indicating the shape, the color, and the size of an object. Consequently, a user has no choice but to go to the particular place to acquire a place-specific code, which is used to control whether or not to permit use of confidential data. Also, it is possible to make it difficult to guess the place-specific code.

Furthermore, the image capturing unit generates, as the image data, three-dimensional modeling data of the sight, and the generation unit generates a plurality of plane images with use of the three-dimensional modeling data, and also generates the place-specific code from the plurality of plane images.

With the above-described structure, the use of a plane image that is generated from a three-dimensional model, which is difficult to be obtained unless measured in the actual particular place, makes it possible to generate a place-specific code that is difficult to be guessed.

Furthermore, the control unit encrypts the confidential data with use of the place-specific code.

With the above-described structure, a user has no choice but to go to the particular place to acquire a decryption key, which is required for decrypting encrypted confidential data. Also, it is possible to make it difficult to guess the decryption key.

Furthermore, the control unit restricts access to the confidential data with use of the place-specific code as an authentication password.

With the above-described structure, a user has no choice but to go to the particular place to acquire an authentication password, which is required for accessing confidential data. Also, it is possible to make it difficult to guess the authentication password.

Furthermore, in a state that the confidential data is not permitted to be used, if a place-specific code indicating a characteristic specific to the particular place matches with the place-specific code indicating the characteristic specific to the place in which the image capturing has been performed, the control unit permits the confidential data to be used.

With the above-described structure, it is possible to restrict a place where confidential data is permitted to be used to the particular place where a place-specific code that shows a characteristic specific to the particular place can be generated.

Furthermore, the control unit changes, in accordance with a degree of consistency between (i) the place-specific code indicating the characteristic specific to the particular place and (ii) the place-specific code indicating the characteristic specific to the place in which the image capturing has been performed, an accessible range of content of the confidential data.

According to the above-described structure, whether or not to permit use of confidential data can be flexibly controlled in parts.

Furthermore, if the place-specific code indicating the characteristic specific to the particular place does not match with the place-specific code indicating the characteristic specific to the place in which the image capturing has been performed, the control unit causes the image capturing unit to change an image capturing direction and capture an image.

According to the above-described structure, whether or not to permit use of confidential data can be flexibly controlled in such that allows slight differences in conditions of when an image is captured.

Furthermore, the image capturing unit stores partial image data that is part of the image data generated from the image captured in the particular place, and keeps capturing images by changing the image capturing direction until acquiring image data that includes data identical to the partial image data at the same place as the partial image data, and outputs the image data that includes the data identical to the partial image data.

With the above-described structure, even though there is a slight difference between (i) an image capturing direction of imaging that is performed when the use of confidential data is disabled, and (ii) an image capturing direction of imaging that is performed when the use of the confidential data is attempted to be permitted, whether or not to permit use of confidential data can be controlled in a manner that allows the slight difference.

Furthermore, if the place-specific code indicating the characteristic specific to the particular place does not match with the place-specific code indicating the characteristic specific to the place in which the image capturing has been performed, the control unit interchanges one bit that is included in the place-specific code indicating the characteristic specific to the place in which the image capturing has been performed, and if the place-specific code that has the one bit interchanged matches with the place-specific code indicating the characteristic specific to the particular place, the confidential data is permitted to be used.

The above-described structure makes it possible to control whether or not to permit use of confidential data, in a manner that allows small changes in a captured image such as image blurring and noise.

Furthermore, the confidential data protection apparatus may include a fraud-detection unit operable to cause the image capturing unit to capture a plurality of images, and in a case that the plurality of images all match with each other, prevent the control unit from permitting the confidential data to be used.

According to the above-described structure, fraudulent attempts to use confidential data without actually going to the particular place, for example, an attempt to show an image capturing unit a scenic picture as an image capturing object, can be detected, and the use of the confidential data can be disabled. As a result, security while the confidential data is in use can be improved.

Furthermore, the generation unit includes: a plurality of coding units, each of which operable to perform coding differently from the other coding units; an environmental information acquisition unit operable to acquire environmental information; a selecting unit operable to select one coding unit from among the plurality of coding units according to the environmental information, whereby the selected one coding unit generates the place-specific code with use of the generated image data.

According to the above-described structure, a coding method appropriate for the environmental information can prevent a place-specific code from being generated incorrectly. Therefore, in the control of whether or not to permit use of confidential data, the environmental information does not affect the judgment result thereof, which can achieve control with higher security.

Furthermore, the environmental information acquisition unit acquires the environmental information that is information indicating luminance intensity obtained by measuring the luminance intensity.

According to the above-described structure, in the control of whether or not to permit use of confidential data, the luminance intensity in the environment does not affect the judgment result thereof, which can achieve control with higher security.

The present invention provides an autonomous mobile robot that restricts use of confidential data to a particular place, the autonomous mobile robot comprising: a storage unit that stores the confidential data including learned information; an image capturing unit operable to capture an image at a place to generate image data; a generation unit operable to generate a place-specific code with use of the generated image data, the place-specific code indicating a characteristic specific to the place at which the image capturing was performed; and an autonomous move control unit operable to, when the confidential data is permitted to be used, perform an autonomous move control with use of the learned information.

According to the above-described structure, a place-specific code, which is used to control whether or not to permit use of confidential data including learned information, can be acquired only if a user actually goes to the particular place. Also, it is possible to make it difficult to guess the place-specific code. Therefore, for confidential data, a place bind having higher security than conventional place binds can be realized.

Furthermore, the learned information is updated with use of information acquired by the robot moving autonomously.

Also, the confidential data includes map information for a route control.

The above-described structure can improve the confidentiality of information that has a higher degree of privacy protection.

The present invention provides a confidential data protection method that restricts use of confidential data to a particular place, the confidential data protection method comprising: an image capturing step for capturing an image at a place to generate image data; a generation step for generating a place-specific code with use of the generated image data, the place-specific code indicating a characteristic specific to the place at which the image capturing was performed; and a control unit operable to control whether or not to permit use of the confidential data, based on the place-specific code.

The present invention provides a computer program used for a confidential data protection apparatus that restricts use of confidential data to a particular place, the computer program comprising: an image capturing step for capturing an image at a place to generate image data; a generation step for generating a place-specific code with use of the generated image data, the place-specific code indicating a characteristic specific to the place at which the image capturing has been performed; and a control step for controlling whether or not to permit use of the confidential data, based on the place-specific code.

The present invention provides an integrated circuit that restricts use of confidential data to a particular place, the integrated circuit comprising: a storage unit that stores the confidential data; an image capturing unit operable to capture an image at a place to generate image data; a generation unit operable to generate a place-specific code with use of the generated image data, the place-specific code indicating a characteristic specific to the place at which the image capturing was performed; and a control unit operable to control whether or not to permit use of the confidential data, based on the place-specific code.

According to the above-described structure, a place-specific code, which is used to control whether or not to permit use of confidential data, can be acquired only if a user actually goes to the particular place. Also, it is possible to make it difficult to guess the place-specific code. Therefore, for confidential data, a place bind having higher security can be realized.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing the structure of an information processing apparatus 1 according to the first embodiment of the present invention;

FIG. 2 is a flow chart showing the processing of when the information processing apparatus 1 according to the first embodiment of the present invention encrypts data;

FIG. 3 is a flow chart showing the processing of when the information processing apparatus 1 according to the first embodiment of the present invention decrypts encrypted data;

FIG. 4 is a flow chart showing the processing of when the information processing apparatus 1 according to the first embodiment of the present invention uses data;

FIG. 5 is a block diagram showing the structure of an information processing apparatus 2 according to the second embodiment of the present invention;

FIG. 6 is a flow chart showing the processing of when the information processing apparatus 2 according to the second embodiment of the present invention protects data;

FIG. 7 is a flow chart showing the processing of when the information processing apparatus 2 according to the second embodiment of the present invention unprotects confidential data;

FIG. 8 is a block diagram showing the structure of a cleaning robot according to the third embodiment of the present invention;

FIG. 9 is a block diagram showing the structure of the information processing unit of the cleaning robot according to the third embodiment of the present invention;

FIG. 10 is a flow chart showing an example operation of the cleaning robot according to the third embodiment of the present invention;

FIG. 11 is a diagram for explaining a situation where the cleaning robot according to the third embodiment of the present invention takes an image of the entrance to an apartment building;

FIG. 12 is a diagram for explaining a situation where the cleaning robot according to the third embodiment of the present invention takes an image of the entrance to the house of a client;

FIG. 13 is a diagram for explaining a situation where the cleaning robot according to the third embodiment of the present invention takes an image of the entrance to the house of a client;

FIG. 14 is a diagram for explaining a situation where the cleaning robot according to the third embodiment of the present invention takes an image of the entrance to the house of a client;

FIG. 15 is a diagram for explaining a situation where the cleaning robot according to the third embodiment of the present invention takes an image of the entrance to the house of a client; and

FIG. 16A is a diagram for explaining three-dimensional modeling data according to the modification of the present invention.

FIG. 16B is a diagram for explaining three-dimensional modeling data according to the modification of the present invention.

### DESCRIPTION OF THE PREFERRED EMBODIMENT

The following describes embodiments of the present invention, with reference to the attached diagrams.

### 1. First Embodiment

An information processing apparatus 1, which is a confidential data protection apparatus according to the first embodiment of the present invention, is a so-called information processing terminal apparatus that can process information stored in, for example, a computer apparatus such as a laptop personal computer, a home electric appliance (a digital still camera, a digital video camera, for example) a cellular phone, a personal handyphone system, and a dedicated portable terminal. The processing includes, for example, input/output of information, and storing information.

The information processing apparatus 1 encrypts and stores confidential data, and realizes a place bind by restricting a place to decrypt data to the place where the data has been encrypted. The confidential data is encrypted with use of a key that has been generated from a scenic image captured in a place where the data is encrypted. The key that has been used for encryption is revoked after the encryption. As for an encryption scheme, a scheme that uses a same key for encryption and decryption is adopted.

In the information processing apparatus 1, in a case of decrypting confidential data that has been encrypted, a user actually goes to a place where the data has been encrypted in order to capture an image of the place to generate a decryption key. If the decryption key matches with the encryption key, the information processing apparatus 1 can decrypt the encrypted confidential data. In this case, it can be assumed that the information processing apparatus 1 is actually positioned in a place where the encryption has been performed.

Note that requiring an exact match between a scenic image captured upon encryption and a scenic image captured upon decryption may cause inconvenience. For example, if a scenic image captured upon encryption shows a small insect, which has been accidentally caught in the image, the decryption key may not match with the encryption key. In the information processing apparatus 1, when a key is generated from a scenic image, the grayscale edge and the like of the scenic image is used, thereby allowing a slight difference and image blurring between a scenic image captured for encryption and a scenic image captured for decryption.

1.1. Structure of Information Processing Apparatus

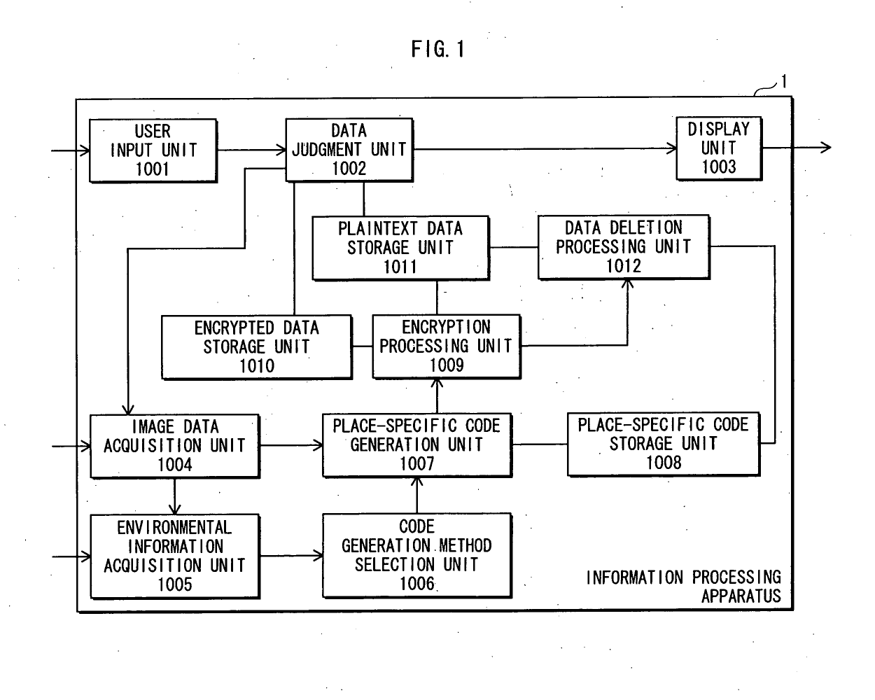

FIG. 1 is a block diagram showing the structure of an information processing apparatus 1 according to the first embodiment of the present invention. As shown in FIG. 1, the information processing apparatus 1 includes a user input unit 1001, a data judgement unit 1002, a display unit 1003, an image data acquisition unit 1004, an environmental information acquisition unit 1005, a code generation method selection unit 1006, a place-specific code generation unit 1007′, a place-specific code storage unit 1008, an encryption processing unit 1009, an encrypted data storage unit 1010, plaintext data storage unit 1011, and a data delete processing unit 1012.

1.1.1. User Input Unit 1001

A user input unit 1001 is connected to an input device, such as a keyboard or a mouse, which is operated by a user to input requests.

Upon receiving a request from the input device, the user input unit 1001 outputs the request to the data judgement unit 1002. The request may be a data protection signal SPRO that indicates a request to encrypt data stored in the information processing apparatus 1, a data unprotection signal SUPR that indicates a request to decrypt encrypted data stored in the information processing apparatus 1, and a data use signal SUSE that indicates a request to display data that is stored in the information processing apparatus 1.

1.1.2. Data Judgement Unit 1002

A data judgement unit 1002 receives, from the user input unit 1001, the data protection signal SPRO, the data unprotection signal SUPR, and the data use signal SUSE, and then performs processing in accordance with each of the received signals.

1.1.2.1. Upon Receipt of Data Protection Signal SPRO

If plaintext data DDATA exists in the plaintext data storage unit 1011, the data judgement unit 1002 outputs the data protection signal SPRO to the image data acquisition unit 1004. If the plaintext data DDATA does not exist in the plaintext data storage unit 1011, the data judgement unit 1002 outputs an error code E1, which indicates that the plaintext data does not exist therein, to the display unit 1003.

1.1.2.2. Upon Receipt of Data Unprotection Signal SUPR

If encrypted data EDATA exists in the encrypted data storage unit 1010, the data judgement unit 1002 acquires a code generation method identifier CID therefrom to output the data unprotection signal SUPR and the code generation method identifier CID to the image data acquisition unit 1004.

If the encrypted data EDATA does not exist in the encrypted data storage unit 1010, the data judgement unit 1002 outputs an error code E2, which indicates that the encrypted data does not exist therein, to the display unit 1003.

1.1.2.3. Upon Receipt of the Data Use Signal SUSE

If plaintext data DDATA exists in the plaintext data storage unit 1011, the data judgement unit 1002 acquires the plaintext data DDATA therefrom to output the plaintext data DDATA to the display unit 1003. If the plaintext data DDATA does not exist in the plaintext data storage unit 1011, the data judgement unit 1002 sends an error code E1, which indicates that the plaintext data does not exist therein, to the display unit 1003.

1.1.3. Display Unit 1003

The display unit 1003 is connected to a display, and shows, on the display, data, images and the like that correspond to data received from the data judgement unit 1002.

Upon receiving the plaintext data DDATA from the data judgement unit 1002, the display unit 1003 shows the plaintext data DDATA on the display.

Also, upon receiving the error code E1 from the data judgement unit 1002, the display unit 1003 shows an error message indicating that “plaintext data does not exist” on the display. Upon receiving the error code E2, the display unit 1003 shows an error message indicating that “encrypted data does not exist” on the display.

1.1.4. Image Data Acquisition Unit 1004

The image data acquisition unit 1004 is connected to a camera module (not shown in figure) that captures scenic images. Here, the camera module captures a scenic image in accordance with an instruction of the image data acquisition unit 1004, and outputs thereto image data PIC indicating the scenic image in digital format.

Upon receiving the data protection signal SPRO from the data judgement unit 1002, the image data acquisition unit 1004 gives an image capturing instruction to the camera module. In response to the instruction, the image data acquisition unit 1004 acquires the image data PIC and the data protection signal SPRO, which are then output to the place-specific code generation unit 1007. Next, the image data acquisition unit 1004 outputs environmental information acquisition signal SGET to the environmental information acquisition unit 1005.

Upon receiving the data unprotection signal SUPR and the code generation method identifier CID from the data judgement unit 1002, the image data acquisition unit 1004 gives the image capturing instruction to the camera module. In response to the instruction, the image data acquisition unit 1004 acquires the image data PIC, the data unprotection signal SUPR, and the code generation method identifier CID, which are then output to the place-specific code generation unit 1007.

1.1.5 Environmental Information Acquisition Unit 1005

The environmental information acquisition unit 1005 is connected to a lux meter module (not shown in figure), which measures luminance intensity (unit: lux). The lux meter module, in accordance with the instruction given by the environmental information acquisition unit 1005, measures the luminance intensity in the environment of the information processing apparatus 1 in order to output the luminance intensity as environmental information SI to the environmental information acquisition unit 1005.

Upon receiving the environmental information acquisition signal SGET from the image data acquisition unit 1004, the environmental information acquisition unit 1005 gives an instruction to measure the luminance intensity to the lux meter module. In response to the instruction, the environmental information acquisition, unit 1005 acquires the environmental information SI from the lux meter module, which is then output to the code generation method selection unit 1006.

1.1.6 Code Generation Method Selection Unit 1006

Upon receiving the environmental information SI from the environmental information acquisition unit 1005, the code generation method selection unit 1006 selects, in accordance with the environmental information SI, one method from among the plurality of code generation methods that are stored in the place-specific code generation unit 1007. Then, the code generation method selection unit 1006 outputs the code generation method identifier CID that corresponds to the selected code generation method to the place-specific code generation unit 1007.

For example, if the luminance intensity indicated by the environmental information SI is 10000 lux or more, color information may collapse. Therefore, a code generation method C1, which is most appropriate for such luminance intensity, is selected. Meanwhile, if the luminance intensity indicated by the environmental information SI is less than 10000 lux, a code generation method C2, which is most appropriate for such luminance intensity, is selected.

1.1.7. Place-Specific Code Generation Unit 1007, and Place-Specific Code Storage Unit 1008

The place-specific code generation unit 1007 contains a plurality of code generation methods including C1 and C2, which generate a place-specific code PCODE from the image data PIC.

Upon receiving the data protection signal SPRO from the image data acquisition unit 1004, the place-specific code generation unit 1007 codes the image data PIC, which is received from the image data acquisition unit 1004, with use of a code generation method that corresponds to the code generation method identifier CID, which is received from the code generation method selection unit 1006, in order to generate the place-specific code PCODE. Then, the place-specific code generation unit 1007 stores the place-specific code PCODE in the place-specific code storage unit 1008, and outputs the data protection signal SPRO to the encryption processing unit 1009.

Also, upon receiving the data unprotection signal SUPR from the image data acquisition unit 1004, the place-specific code generation unit 1007 codes the image data PIC, which is received from the image data acquisition unit 1004, with use of a code generation method that corresponds to the code generation method identifier CID, which is received from the code generation method selection unit 1006, in order to generate the place-specific code PCODE.

Then, the place-specific code generation unit 1007 stores the place-specific code PCODE in the place-specific code storage unit 1008, and outputs the data unprotection signal SUPR to the encryption processing unit 1009.

Note that, in the present embodiment, the place-specific code PCODE is assumed to be 128 bits.

The following describes two types of code processing, which are performed with use of the above-described code generation methods C1 and C2.

1.1.7.1. Code Processing with Use of Code Generation Method C1

In the following processing, edge information of the image data PIC is used for coding. First, the image data PIC is divided into eight parts in lengthwise, and also eight parts in widthwise, whereby 64 pieces of small regional image data can be obtained. Next, image processing is performed on a piece of regional image data, so that an edge (boundary line) element, which is a boundary of characteristics including density values, colors, and patterns (texture), is extracted. A method of extracting an edge element from image data is disclosed in Non-Patent Document 1, for example. Therefore, the explanation thereof is omitted. Then, in the regional image data whose edge element has been extracted, the direction of the edge element thereof is judged. For example, the direction of the edge element is judged whether the direction falls into any one of the directions among (i) up/down direction, (ii) crosswise direction, (iii) diagonal direction connecting upper left and bottom right, and (iv) diagonal direction connecting upper right and bottom left. Then, the judged direction of the edge element is set to be the characteristic quantity of the regional image data. Note that there may be a case in which the edge element does not exist.

In the present embodiment, each direction of the edge elements is allocated a 2-bit code respectively. Specifically, an edge element in up/down (vertical) direction is allocated a 2-bit code 00. An edge element in crosswise (horizontal) direction is allocated a code 01. An edge element in a diagonal direction connecting upper left and bottom right is allocated a code 10. An edge element in a diagonal direction connecting upper right and bottom left, or the case in which the edge element does not exist is allocated a code 11.

Starting from the upper left regional image data that constitutes the image data PIC to all 64 pieces of regional image data, the code generation method C1 judges the directions of edge elements and determines a 2-bit code that corresponds to each of the edge elements as described above.

A resultant bit code generated in such that 2-bit codes according to all the 64 pieces of regional image data are connected to each other is set to be a place-specific code PCODE of 128 bits.

Note that, unless the regional image data changes considerably, the edge element of the regional image data does not change. Therefore, even though a certain length of time has passed by the time the place-specific code PCODE is generated again, and the captured image that is the basis for regenerating the place-specific code PCODE is slightly changed from the image that has been taken at the previous time, the same place-specific code PCODE as the previously generated code can be generated.

In other words, the code generation method C1 allows slight changes (image blurring, noise) that may occur when images are captured.

1.1.7.2. Code Processing with Use of Code Generation Method C2

In the following processing, color information indicating RGB of the image data PIC is used for coding. Here, each of the pixels that constitute the image data PIC is represented by three values that include R value (red), G value (green), and B value (blue).

First, the image data PIC is divided into twelve parts in lengthwise, and also twelve parts in widthwise, whereby 144 pieces of small regional image data can be obtained. Next, for each of the pixels that constitute the pieces of small regional image data, (i) the average value of R values, (ii) the average value of G values, and (iii) the average value of B values are calculated. Then, among the R values, G values, and B values, the color which has the highest average value (representative color) is set to be the characteristic quantity of the regional image data. If the representative color of the regional image data is R (red), a code 0 is allocated. If the representative color of the regional image data is either G (green) or B (blue), a code 1 is allocated.

Then, in the picture data PIC, starting from the upper left regional image data that constitutes the image data PIC, a code corresponding to each representative color of the pieces of the regional data is allocated in sequence. Then, the allocated codes are successively connected to each other as upper bits. When the result of the connection reaches 128 bits, the processing is completed.

Note that, unless the regional image data changes considerably, the representative color of the regional image data rarely changes. Therefore, even though a certain length of time has passed by the time the place-specific code PCODE is regenerated, and the captured image that is the basis for generating the place-specific code PCODE is slightly changed from the image that has been taken at the previous time, as long as the dominance degree of color does not change, the same place-specific code PCODE as the previously generated code can be generated. In other words, the code generation method C2 allows slight changes (image blurring, noise) that may occur when images are captured.

The place-specific code storage unit 1008 stores the place-specific code PCODE of 128 bits.

1.1.8. Encryption Processing Unit 1009

Upon receiving, from the place-specific code generation unit 1007, either the data protection signal SPRO or the data unprotection signal SUPR, the encryption processing unit 1009 performs encryption processing that corresponds to the received signal.

Upon receiving, from the place-specific code generation unit 1007, the data protection signal SPRO and the code generation method identifier CID, the encryption processing unit 1009 acquires the plaintext data DDATA from the plaintext data storage unit 1011. Then, the encryption processing unit 1009 acquires the place-specific code PCODE from the place-specific code storage unit 1008. Next, with the place-specific code PCODE as an encryption key, and the plaintext data DDATA as in plaintext, the encryption processing unit 1009 encrypts the plaintext data DDATA with use of AES (Advanced Encryption Standard) encryption algorithm to generate encrypted data EDATA. AES algorithm is publicly well known, and therefore the explanation thereof is omitted. Then, the encryption processing unit 1009 stores the encrypted data EDATA and the code generation method identifier CID in the encrypted data storage unit 1010. Finally, the encryption processing unit 1009 outputs the data protection signal SPRO to the data deletion processing unit 1012.

Upon receiving the data unprotection signal SUPR from the place-specific code generation unit 1007, the encryption processing unit 1009 acquires the encrypted data EDATA from the encrypted data storage unit 1010. Then, the encryption processing unit 1009 acquires the place-specific code PCODE from the place-specific code storage unit 1008. Next, with the place-specific code PCODE as a decryption key, the encryption processing unit 1009 decrypts the encrypted data EDATA that is encrypted text using AES (Advanced Encryption Standard) decryption algorithm to generate plaintext data DDATA. Then, the encryption processing unit 1009 stores the plaintext data DDATA in the plaintext data storage unit 1011. Finally, the encryption processing unit 1009 outputs the data unprotection signal SUPR to the data deletion processing unit 1012.

1.1.9. Encrypted Data Storage Unit 1010, Plaintext Data Storage Unit 1011, and Data Deletion Processing Unit 1012

The encrypted data storage unit 1010 stores the encrypted data EDATA and the code generation method identifier CID.

The plaintext data storage unit 1011 stores the plaintext data DDATA.

The data deletion processing unit 1012 performs delete processing for each type of data.

Upon receiving the data protection signal SPRO from the encryption processing unit 1009, the data deletion processing unit 1012 deletes the plaintext data DDATA that is stored in the plaintext data storage unit 1011. After that, the data deletion processing unit 1012 deletes the place-specific code PCODE that is stored in the place-specific code storage unit 1008.

Upon receiving the data unprotection signal SUPR from the encryption processing unit 1009, the data deletion processing unit 1012 deletes the place-specific code PCODE that is stored in the place-specific code storage unit 1008.

1.2. Operations of Information Processing Apparatus

The following describes the operations of the information processing apparatus 1 that has the above-described structure. For the sake of the explanation, the operations are divided into three stages, which are the operations when: the data is encrypted (protected), the data is decrypted (unprotected), and the data is used.

1.2.1. Operations when Data is Encrypted

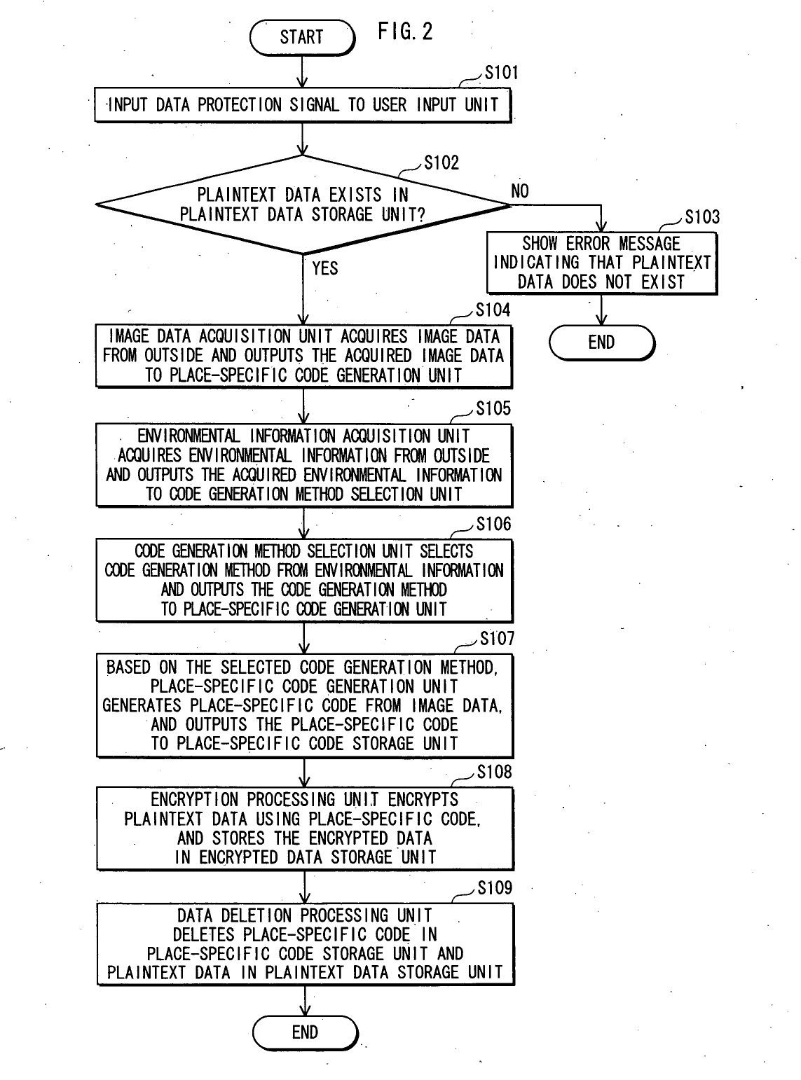

The following describes the operations when the information processing apparatus 1 encrypts data that is stored therein, with reference to the flow chart of FIG. 2.

First, a user requests to encrypt the data using the input device. The user input unit 1001 receives, from the input device, the data protection signal SPRO that corresponds to the request in order to output the signal to the data judgement unit 1002 (step S101).

Upon receiving the data protection signal SPRO from the user input unit 1001, the data judgement unit 1002 outputs, if the plaintext data DDATA exists in the plaintext data storage unit 1011 (step S102: YES), the data protection signal SPRO to the image data acquisition unit 1004.

Upon receiving the data protection signal SPRO from the data judgement unit 1002, the image data acquisition unit 1004 acquires the image data PIC from the camera module, and then outputs the acquired image data PIC and the data protection signal SPRO to the place-specific code generation unit 1007. Finally, the image data acquisition unit 1004 outputs the environmental information acquisition signal SGET to the environmental information acquisition unit 1005 (step S104).

Upon receiving the environmental information acquisition signal SGET, the environmental information acquisition unit 1005 measures the luminance intensity. Then, the environmental information acquisition unit 1005 outputs the measurement result of the luminance intensity as the environmental information SI to the code generation method selection unit 1006 (step S105).

Upon receiving the environmental information SI, the code generation method selection unit 1006 acquires the code generation method identifier CID that corresponds to the most appropriate code generation method in accordance with the environmental information SI. Then, the code generation method selection unit 1006 outputs the code generation method identifier CID to the place-specific code generation unit 1007 (step S106).

The place-specific code generation unit 1007 receives the image data PIC and the data protection signal SPRO from the image data acquisition unit 1004, and also receives the code generation method identifier CID from the code generation method selection unit 1006. Then, the place-specific code generation unit 1007 generates, with use of the code generation method corresponding to the code generation method identifier CID, the place-specific code PCODE from the image data PIC to store the place-specific code PCODE in the place-specific code storage unit 1008. Finally, the place-specific code generation unit 1007 outputs the data protection signal SPRO to the encryption processing unit 1009 (step S107).

Upon receiving the data protection signal SPRO and the code generation method identifier CID, the encryption processing unit 1009 acquires the plaintext data DDATA from the plaintext data storage unit 1011, and also acquires the place-specific code PCODE from the place-specific code storage unit 1008.

Subsequently, with the place-specific code PCODE as the encryption key, and the plaintext data DDATA as in plaintext, the encryption processing unit 1009 encrypts the plaintext data DDATA using AES encryption algorithm to generate the encrypted data EDATA. Then, the encryption processing unit 1009 stores the encrypted data EDATA and the code generation method identifier CID in the encrypted data storage unit 1010, and outputs the data protection signal SPRO to the data deletion processing unit 1012 (step S108).

Upon receiving the data protection signal SPRO from the encryption processing unit 1009, the data deletion processing unit 1012 deletes the plaintext data DDATA that is stored in the plaintext data storage unit 1011. After that, the data deletion processing unit 1012 deletes the place-specific code PCODE that is stored in the place-specific code storage unit 1008 to complete the processing (step S109).

Also, in step S102, when judging that the plaintext data DDATA does not exist in the plaintext data storage unit 1011 (step S102: NO), the data judgement unit 1002 outputs an error code E1, which indicates that the plaintext data does not exist in the plaintext data storage unit 1011, to the display unit 1003. Upon receiving the error code E1, the display unit 1003 shows an error message indicating that “plaintext data does not exist” on the display (step S103) to complete the processing.

1.2.2. Operations when Data is Decrypted

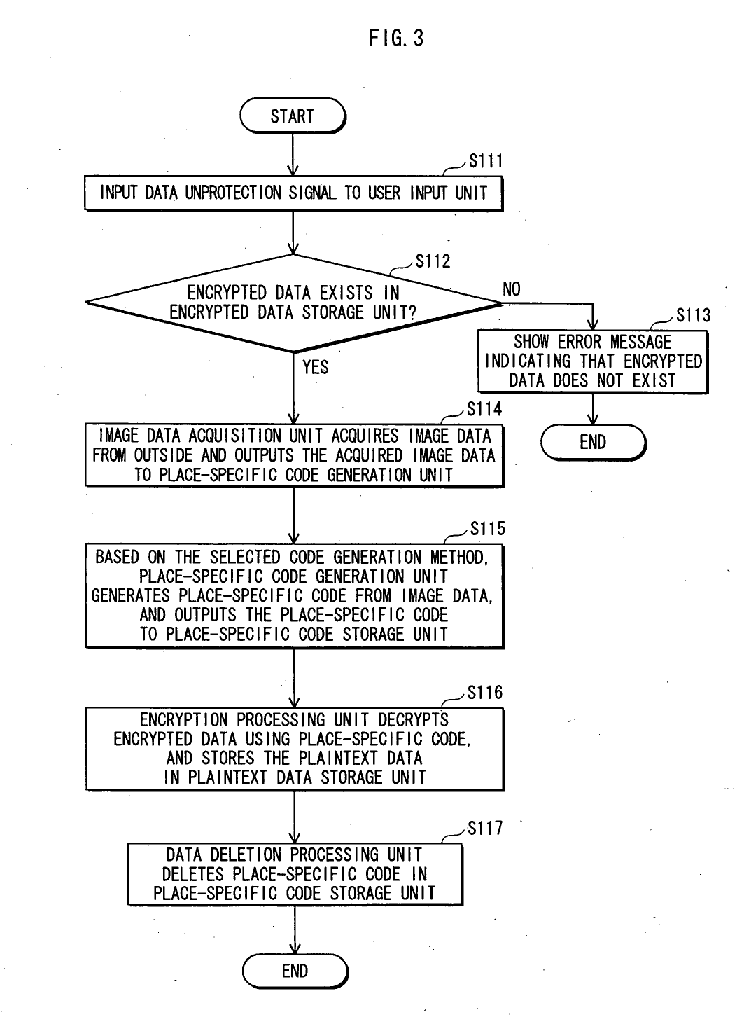

The following describes the operations when the information processing apparatus 1 decrypts the encrypted data that is stored therein, with reference to the flow chart of FIG. 3.

First, a user requests to decrypt data using the input device. The user input unit 1001 receives, from the input device, the data unprotection signal SUPR that corresponds to the request in order to output the signal to the data judgement unit 1002 (step S111).

Upon receiving the data unprotection signal SUPR, the data judgement unit 1002 acquires, if the encrypted data EDATA and the code generation method identifier CID exist in the encrypted data storage unit 1010 (step S112: YES), the code generation method identifier CID from the encrypted data storage unit 10. Then, the data judgement unit 1002 outputs the data unprotection signal SUPR and the code generation method identifier CID to the image data acquisition unit 1004.

Upon receiving the data unprotection signal SUPR and the code generation method identifier CID from the data judgement unit 1002, the image data acquisition unit 1004 acquires the image data PIC from the camera module. Then, the image data acquisition unit 1004 outputs, to the place-specific code generation unit 1007, the acquired image data PIC, the data unprotection signal SUPR, and the code generation method identifier CID (step S114).

Upon receiving the image data PIC, the data unprotection signal SUPR, and the code generation method identifier CID, the place-specific code generation unit 1007 generates, with use of the code generation method that corresponds to the code generation method identifier CID, the place-specific code PCODE from the image data PIC. Then, the place-specific code generation unit 1007 stores the place-specific code PCODE in the place-specific-code storage unit 1008, and outputs the data unprotection signal SUPR to the encryption processing unit 1009 (step S115).

Upon receiving the data unprotection signal SUPR from the place-specific code generation unit 1007, the encryption processing unit 1009 acquires the encrypted data EDATA from the encrypted data storage unit 1010, and also acquires the place-specific code PCODE from the place-specific code storage unit 1008. Then, with the place-specific code PCODE as the decryption key, the encryption processing unit 1009 decrypts the encrypted data EDATA that is encrypted text, with use of AES decryption algorithm to generate the plaintext data DDATA. Then, the encryption processing unit 1009 stores the plaintext data DDATA in the plaintext data storage unit 1011. Finally, the encryption processing unit 1009 outputs the data unprotection signal SUPR to the data deletion processing unit 1012. (step S116).

Upon receiving the data unprotection signal SUPR, the data deletion processing unit 1012 deletes the place-specific code PCODE that is stored in the place-specific code storage unit 1008 to complete the processing (step S117).

Meanwhile, in step S112, when judging that the encrypted data EDATA does not exist in the encrypted data storage unit 1010 (step S112: NO), the data judgement unit 1002 outputs an error code E2, which indicates that the encrypted data does not exist in the encrypted data storage unit 1010, to the display unit 1003. Upon receiving the error code E2, the display unit 1003 shows an error message indicating that “encrypted data does not exist” on the display to complete the processing (step S113).

1.2.3. Operations when Data is Used

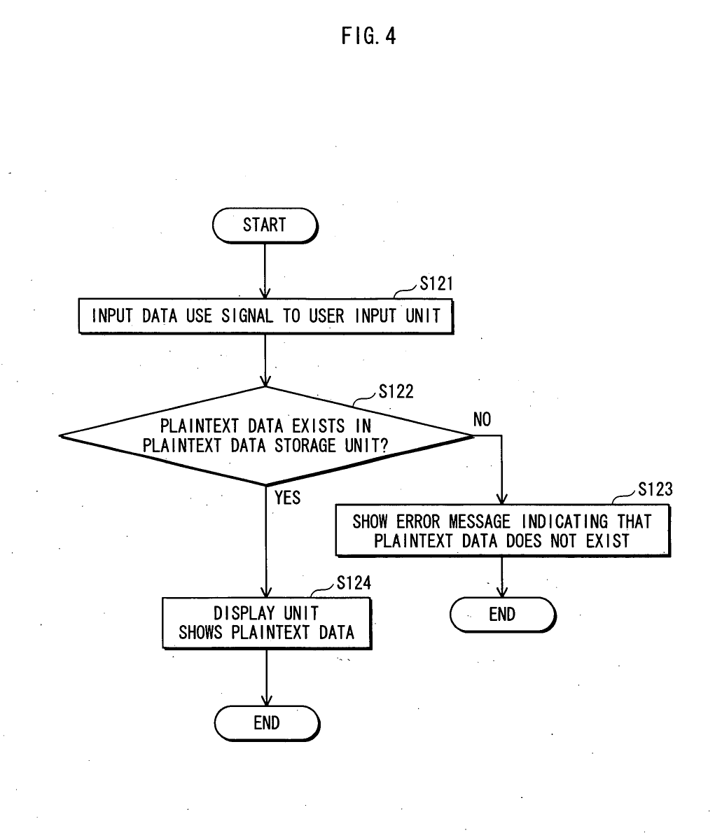

The following describes the operations when the information processing apparatus 1 displays data that is stored therein, with reference to the flow chart of FIG. 4.

First, a user requests to display data using the input device. The user input unit 1001 receives, from the input device, the data use signal SUSE that corresponds to the request in order to output the signal to the data judgement unit 1002 (step S121).

Upon receiving the data use signal SUSE, the data judgement unit 1002 acquires, if the plaintext data DDATA exists in the plaintext data storage unit 1011 (step S122: YES), the plaintext data DDATA from the plaintext data storage unit 1011 to output the plaintext data DDATA to the display unit 1003.

Meanwhile, if the plaintext data DDATA does not exist in the plaintext data storage unit 1011 (step S122: NO), the data judgement unit 1002 sends an error code E1, which indicates that the plaintext data does not exist therein, to the display unit 1003.

Upon receiving the error code E1, the display unit 1003 shows an error message indicating that “plaintext data does not exist” on the display to complete the processing (step S123).

Upon receiving the plaintext data DDATA from the data judgement unit 1002, the display unit 1003 directly shows the plaintext data DDATA to complete the processing (step S124).

### 2. Second Embodiment

In the information processing apparatus 1 of the first embodiment, the encryption processing of data is performed based on the place-specific code, which can be obtained from the image data.

An information processing apparatus 2 of the present embodiment stores a second place-specific code, which is a place-specific code that is generated when confidential data is protected. If the access to the confidential data is requested after the data has been protected, the information processing apparatus 2 acquires the image data again, in order to obtain the place-specific code from the image data. Then, the information processing apparatus 2 controls the access to the confidential data based on the degree of consistency between the place-specific code and the second place-specific code. The above-described point is different from the first embodiment.

2.1. Structure of Information Processing Apparatus 2

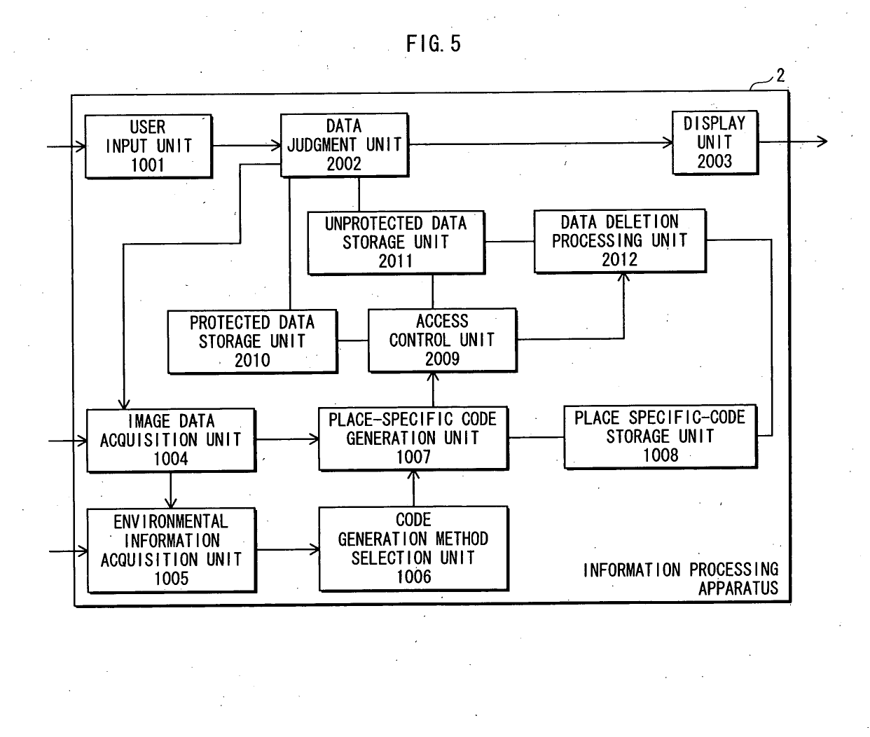

FIG. 5 is a block diagram showing the structure of the information processing apparatus 2 according to the second embodiment of the present invention. As shown in FIG. 5, the information processing apparatus 2 includes the user input unit 1001, a data judgement unit 2002, a display unit 2003, the image data acquisition unit 1004, the environmental information acquisition unit 1005, the code generation method selection unit 1006, the place-specific code generation unit 1007, the place-specific code storage unit 1008, an access control unit 2009, a protected data storage unit 2010, an unprotected data storage unit 2011, and a data deletion processing unit 2012. Here, the user input unit 1001, the image data acquisition unit 1004, the environmental information acquisition unit 1005, the code generation method selection unit 1006, the place-specific code generation unit 1007, and the place-specific code storage unit 1008 are the same components as those of the information processing apparatus 1 of the first embodiment. Therefore, descriptions thereof are omitted.

2.1.1. Data Judgement Unit 2002

The data judgement unit 2002 receives, from the user input unit 1001, the data protection signal SPRO, the data unprotection signal SUPR, and the data use signal SUSE, and performs processing according to the received signals.

2.1.1.1. Upon Receipt of Data Protection Signal SPRO

If the use data UDATA exists in the use data storage unit 2011, the data judgement unit 2002 outputs the data protection signal SPRO to the image data acquisition unit 1004. If the use data UDATA does not exist in the use data storage unit 2011, the data judgement unit 1002 outputs the error code E1, which indicates that the use data does not exist therein, to the display unit 2003.

2.1.1.2. Upon Receipt of Data Unprotection Signal SUPR

If confidential data CDATA and the code generation method identifier CID exist in the protected data storage unit 2010, the data judgement unit 2002 acquires the code generation method identifier CID from the protected data storage unit 2010, and outputs the data unprotection signal SUPR and the code generation method identifier CID to the image data acquisition unit 1004.

Meanwhile, if the confidential data CDATA does not exist in the protected data storage unit 2010, the data judgement unit 2002 outputs an error code E2, which indicates that the confidential data does not exist therein, to the display unit 2003.

2.1.1.3. Upon Receipt of the Data Use Signal SUSE

If the usage data UDATA exists in the unprotected data storage unit 2011, the data judgement unit 2002 acquires the usage data UDATA from the unprotected data storage unit 2011 to output the usage data UDATA to the display unit 2003. If the usage data UDATA does not exist in the unprotected data storage unit 2011, the data judgement unit 2002 sends an error code E1, which indicates that the usage data does not exist therein, to the display unit 2003.

2.1.2. Display Unit 2003

The display unit 2003 is connected to a display, and shows, on the display, data, images and the like that correspond to data received from the data judgement unit 2002.

Upon receiving the usage data UDATA from the data judgement unit 2002, the display unit 2003 directly shows the usage data UDATA on the display. Also, upon receiving the error code E1 from the data judgement unit 2002, the display unit 2003 shows an error message indicating that “usage data does not exist” on the display. Upon receiving the error code E2, the display unit 2003 shows an error message indicating that “confidential data does not exist” on the display.

2.1.3. Access Control Unit 2009

The access control unit 2009 controls the access of the confidential data stored in the information processing apparatus 2.

2.1.3.1. Upon Receipt of Data Protection Signal SPRO and Code Generation Method Identifier CID from Place-Specific Code Generation Unit 1007

The access control unit 2009 acquires the usage data UDATA from the unprotected data storage unit 2011, and also acquires the place-specific code PCODE from the place-specific code storage unit 1008. Subsequently, the access control unit 2009 stores the usage data UDATA in the protected data storage unit 2010 as the confidential data CDATA, and stores the place-specific code PCODE in the protected data storage unit 2010 as the second place-specific code PCODE2, and further stores the code generation method identifier CID in the protected data storage unit 2010. Finally, the access control unit 2009 outputs the data protection signal SPRO to the data deletion processing unit 2012.

2.1.3.2. Upon Receipt of Data Unprotection Signal SUPR from Place-Specific Code Generation Unit 1007

The access control unit 2009 acquires the second place-specific code PCODE from the protected data storage unit 2010, and also acquires the place-specific code PCODE from the place-specific code storage unit 1008. Then, the access control unit 2009 calculates the number of matching bit values between the place-specific code PCODE and the second place-specific code. Then, if the ratio of the number of matching bit values is equal to or higher than a predetermined ratio (90%, for example), the access control unit 2009 acquires the confidential data CDATA from the protected data storage unit 2010, and stores the confidential data CDATA in the unprotected data storage unit 2011 as the usage data UDATA. Finally, the access control unit 2009 outputs the data unprotection signal SUPR to the data deletion processing unit 2012.

2.1.4. Protected Data Storage Unit 2010, Unprotected Data Storage Unit 2011, and Data Deletion Processing Unit 2012

The protected data storage unit 2010 stores the confidential data CDATA, the code generation method identifier CID, and the second place-specific code PCODE2.

The unprotected data storage unit 2011 stores the usage data UDATA.

The data deletion processing unit 2012 performs delete processing for each type of data.

Upon receiving the data protection signal SPRO from the access control unit 2009, the data deletion processing unit 2012 deletes the usage data UDATA stored in the unprotected data storage unit 2011, and also deletes the place-specific code PCODE stored in the place-specific code storage unit 1008.

Upon receiving the data unprotection signal SUPR from the access control unit 2009, the data deletion processing unit 2012 deletes the place-specific code PCODE stored in the place-specific code storage unit 1008.

2.2. Operations of Information Processing Apparatus 2

The following describes the operations of the information processing apparatus 2 that has the above-described structure. For the sake of the explanation, the operations are divided into two stages, which are the operations when the usage data is protected, and the operations when the confidential data is unprotected. Note that, in the present embodiment, operations when data is used is the same as the operations when data is used (see 1.2.3. above), which are performed by the information processing apparatus 1 of the first embodiment. Therefore, descriptions thereof are omitted.

2.2.1. Operations when Usage Data is Protected

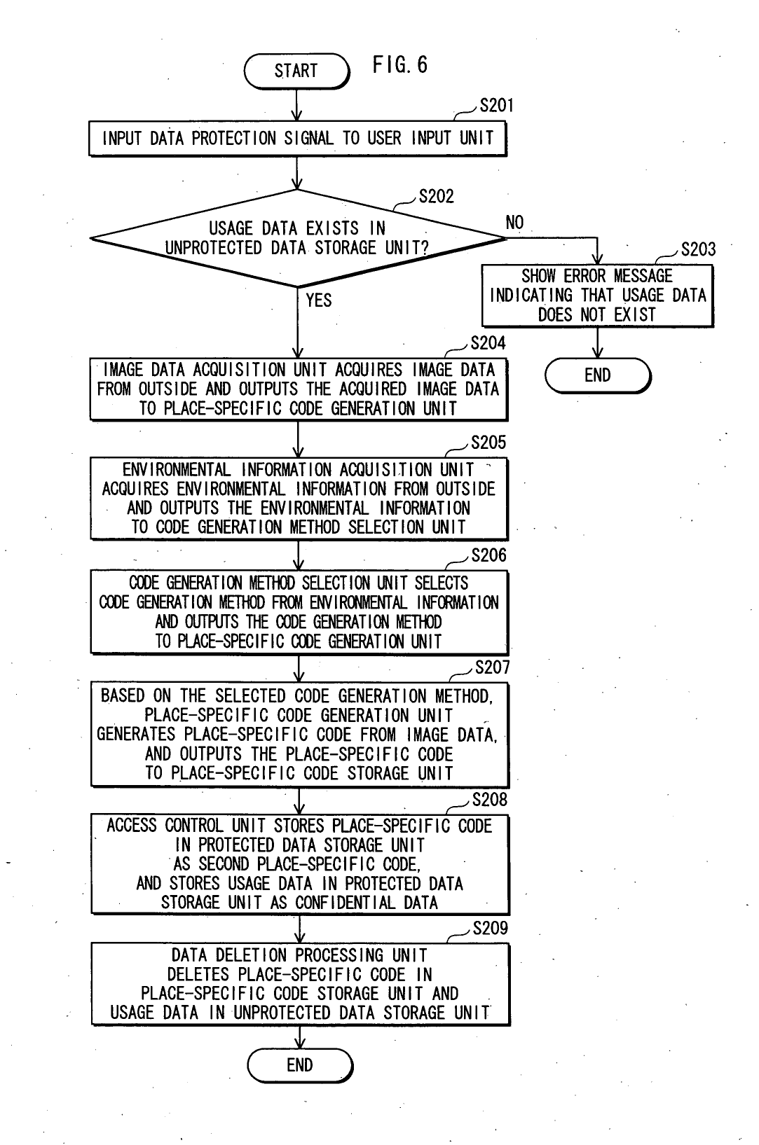

The following describes the operations when the information processing apparatus 2 protects usage data that is stored therein, with reference to the flow chart of FIG. 6.

First, a user requests to protect data using the input device. The user input unit 1001 receives, from the input device, the data protection signal SPRO that corresponds to the request in order to output the signal to the data judgement unit 2002 (step S201).

Upon receiving the data protection signal SPRO from the user input unit 1001, the data judgement unit 2002 outputs, if the usage data UDATA exists in the unprotected data storage unit 2011 (step S202: YES), the data protection signal SPRO to the image data acquisition unit 1004.

Upon receiving the data protection signal SPRO, the image data acquisition unit 1004 acquires the image data PIC from the camera module, and then outputs the acquired image data PIC and the data protection signal SPRO to the place-specific code generation unit 1007. Finally, the image data acquisition unit 1004 outputs the environmental information acquisition signal SGET to the environmental information acquisition unit 1005 (step S204).

Upon receiving the environmental information acquisition signal SGET, the environmental information acquisition unit 1005 measures the luminance intensity. Then, the environmental information acquisition unit 1005 outputs the measurement result of the luminance intensity as the environmental information SI to the code generation method selection unit 1006 (step S205).

Upon receiving the environmental information SI, the code generation method selection unit 1006 acquires the code generation method identifier CID that corresponds to the most appropriate code generation method in accordance with the environmental information SI. Then, the code generation method selection unit 1006 outputs the code generation method identifier CID to the place-specific code generation unit 1007 (step S206).

The place-specific code generation unit 1007 receives the image data PIC and the data protection signal SPRO from the image data acquisition unit 1004, and also receives the code generation method identifier CID from the code generation method selection unit 1006. Then, the place-specific code generation unit 1007 generates, with use of the code generation method corresponding to the code generation method identifier CID, the place-specific code PCODE from the image data PIC.

The place-specific code generation unit 1007 stores the place-specific code PCODE in the place-specific code storage unit 1008, and then outputs the data protection signal SPRO to the access control unit 2009 (step S207).

Upon receiving the data protection signal SPRO, the access control unit 2009 acquires the usage data UDATA from the unprotected data storage unit 2011, and also acquires the place-specific code PCODE from the place-specific code storage unit 1008. Subsequently, the access control unit 2009 stores the usage data UDATA in the protected data storage unit 2010 as the confidential data CDATA, and also stores the place-specific code PCODE in the protected data storage unit 2010 as the second place-specific code PCODE2. Finally, the access control unit 2009 outputs the data protection signal SPRO to the data deletion processing unit 2012 (step S208).

Upon receiving the data protection signal SPRO, the data deletion processing unit 2012 deletes the usage data UDATA stored in the unprotected data storage unit 2011, and also deletes the place-specific code PCODE stored in the place-specific code storage unit 1008, to complete the processing (step S209).

Meanwhile, in step S202, if the usage data UDATA does not exist in the unprotected data storage unit 2011 (step S202: NO), the data judgement unit 2002 outputs the error code E1, which indicates that the usage data does not exist therein, to the display unit 2003.

Upon receiving the error code E1, the display unit 2003 shows an error message indicating that “usage data does not exist” on the display to complete the processing (step S203).

2.2.2. Operations when Confidential Data is Unprotected

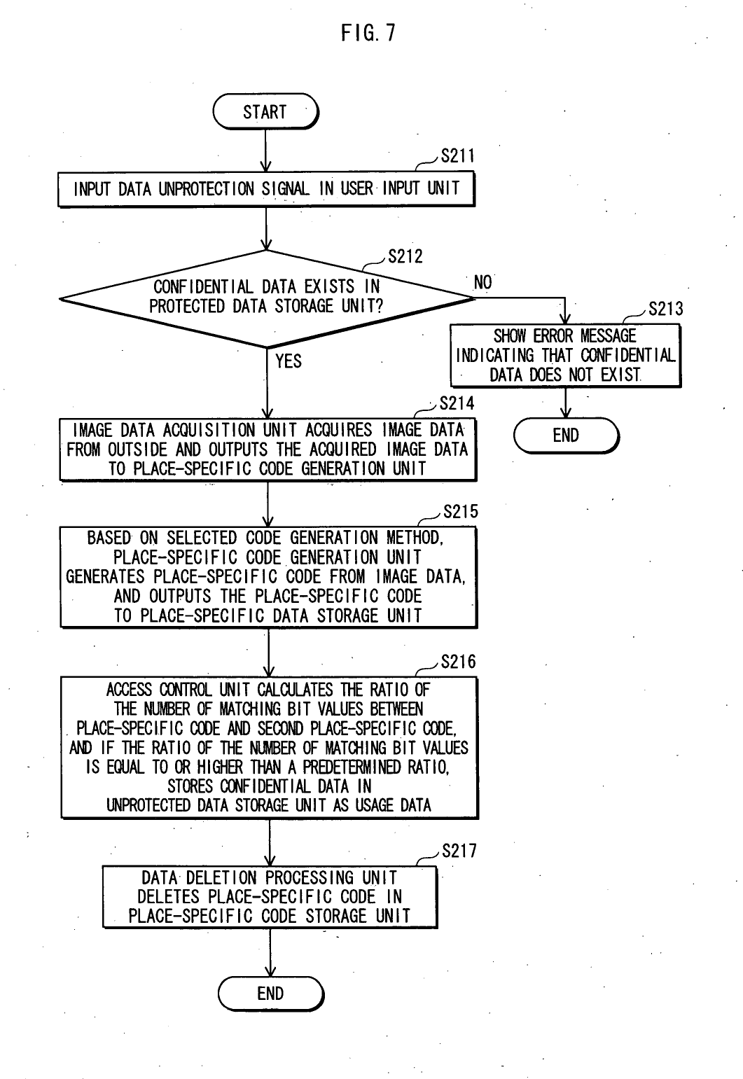

The following describes the operations when the information processing apparatus 2 unprotects the confidential data that is stored therein, with reference to the flow chart of FIG. 7.

First, a user requests to unprotect data using the input device. The user input unit 1001 receives, from the input device, the data unprotection signal SUPR that corresponds to the request in order to output the signal to the data judgement unit 2002 (step S211).

Upon receiving the data unprotection signal SUPR, the data judgement unit 2002 acquires, if the confidential data CDATA, the code generation method identifier CID, and the second place-specific code PCODE2 exist in the protected data storage unit 2010 (step S212: YES), the ode generation method identifier CID from the protected data storage unit 2010. Then, the data judgement unit 2002 outputs the data unprotection signal SUPR and the code generation method identifier CID to the image data acquisition unit 1004.

Upon receiving the data unprotection signal SUPR and the code generation method identifier CID, the image data acquisition unit 1004 acquires the image data PIC from an outside source, and then outputs, to the place-specific code generation unit 1007, the acquired image data PIC, the data unprotection signal SUPR, and the code generation method identifier CID (step S214).

Upon receiving, from the image data acquisition unit 1004, the acquired image data PIC, the data unprotection signal SUPR, and the code generation method identifier CID, the place-specific code generation unit 1007 uses a code generation method corresponding to the code generation method identifier CID in order to generate the place-specific code PCODE from the image data PIC. Subsequently, the place-specific code generation unit 1007 stores the place-specific code PCODE in the place-specific code storage unit 1008, and finally outputs the data unprotection signal SUPR to the access control unit 2009 (step S215).

Upon receiving the data unprotection signal SUPR, the access control unit 2009 acquires the second place-specific code PCODE from the protected data storage unit 2010, and also acquires the place-specific code PCODE from the place-specific code storage unit 1008. Then, the access control unit 2009 calculates the number of matching bit values between the place-specific code PCODE and the second place-specific code. Then, if the ratio of the number of matching bit values is equal to or higher than a predetermined ratio (90%, for example), the access control unit 2009 acquires the confidential data CDATA from the protected data storage unit 2010, and stores the confidential data CDATA in the unprotected data storage unit 2011 as the usage data UDATA. Finally, the access control unit 2009 outputs the data unprotection signal SUPR to the data deletion processing unit 2012 (step S216).

Upon receiving the data unprotection signal SUPR, the data deletion processing unit 2012 deletes the place-specific code PCODE that is stored in the place-specific code storage unit 1008 to complete the processing (step S217).

In step S212, if the confidential data CDATA, the code generation method identifier CID, and the second place-specific code PCODE2 do not exist in the protected data storage unit 2010 (step S212: NO), the data judgement unit 2002 outputs the error code E2, which indicates that the confidential data does not exist therein, to the display unit 2003.

Upon receiving the error code E2, the display unit 2003 shows an error-message indicating that “confidential data does not exist” on the display to complete the processing (step S213).

### 3. Third Embodiment

In the third embodiment, the information processing apparatuses 1 and 2, which are described in the above embodiments, are applied to an autonomous mobile robot. In the descriptions below, the autonomous robot is assumed to be a cleaning robot that moves autonomously. For a better understanding of the present embodiment, the outline of the background of cleaning robots is provided first, followed by the descriptions of the structure thereof and the operations thereof.

Cleaning robots are highly advanced and therefore expected to be considerably expensive. As a result, it is more likely that a single cleaning robot is shared among a plurality of housing units (apartment building, for example) rather than being owned by a single house. Also, a cleaning robot may be rented only when needed. Here, when cleaning houses, a cleaning robot gathers various pieces of information by using sensors in order to clean each of the houses efficiently. For example, the information may include the room layout of the house of a client, the family structure of the client, a time when the client is present in his/her home, part of the house of the client that is particularly dirty, and the images of the house of the client. It is efficient that once the information is collected, the cleaning robot stores the information so that the robot can use the information again when the robot visits the house of the same client. However, such personal information of the client must be managed securely in order to prevent the information from leaking.

In the case that the cleaning robot is a rental, however, there is a possibility that, a maintenance agency may view the data collected by a cleaning robot after the robot has been returned. A cleaning robot of the present invention prevents collected personal information from being viewed even after the robot has been returned.

Here, the cleaning robot captures an image of an entrance to the house (front door of the house) of a client. Then, using an information processing apparatus, the cleaning robot generates an encryption key from the image data to decrypt the stored information such as the room layout of the house of the client. Then, based on the decrypted information such as the room layout of the house of the client, the cleaning robot cleans the house efficiently while moving autonomously. After the cleaning has been completed, the cleaning robot captures an image of the entrance to the house (front door of the house) of the client again, and generates an encryption key from the data of the captured image (referred to as captured image data herein after) using the information processing apparatus. Then, the cleaning robot encrypts the stored information such as the room layout of the house of the client by using the encryption key, and goes back to the maintenance agency. Therefore, the maintenance agency cannot obtain the information indicating the house of the client even though the agency accesses inside the cleaning robot. As a result, the personal information of the client does not leak to the outside.

3.1. Structure of Cleaning Robot 3

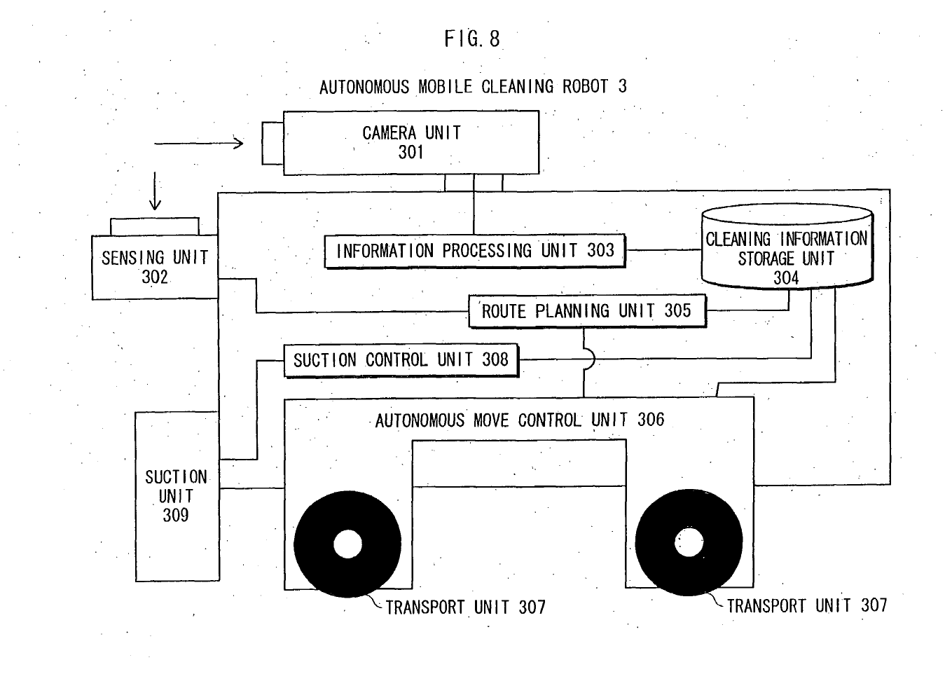

FIG. 8 is a block diagram showing the structure of a cleaning robot 3 according to the third embodiment of the present invention. As shown in FIG. 8, the cleaning robot 3 includes a camera unit 301, a sensing unit 302, an information processing unit 303, a cleaning information storage unit 304, a route planning unit 305, an autonomous move control unit 306, a transport unit 307, a suction control unit 308, and a suction unit 309.

The camera unit 301 captures an image, and outputs, to the information processing unit 303, the image as the image data PIC in a digital format.

The sensing unit 302 acquires environmental information indicating the environment of the cleaning robot 3. The environmental information is used for the cleaning robot 3 to move autonomously by measuring the positions of walls, objects and such.

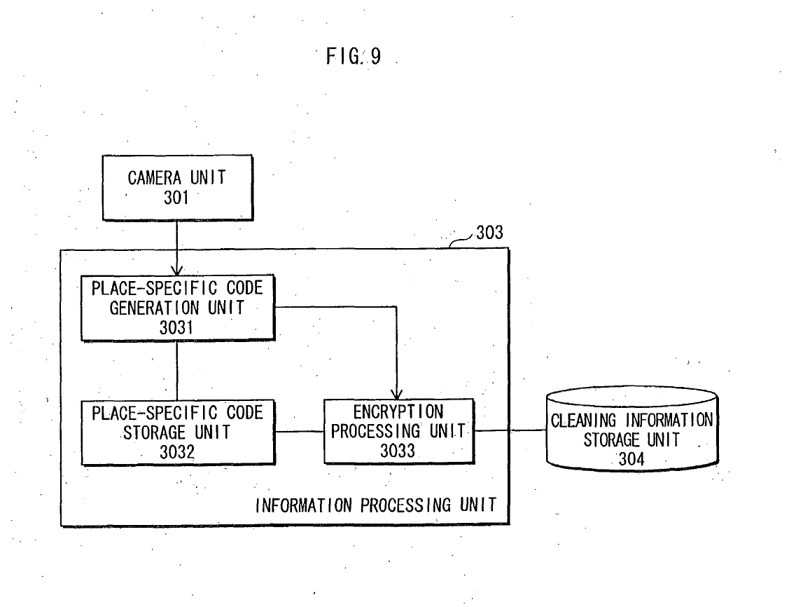

Upon receiving the image data PIC from the camera unit 301, the information processing unit 303 generates an encryption key K from the image data PIC. As shown in FIG. 9, the information processing unit 303 includes a place-specific code generation sub-unit 3031, a place-specific code storage sub-unit 3032, and an encryption processing sub-unit 3033.

Here, the place-specific code generation sub-unit 3031 and the place-specific code storage sub-unit 3032 are the same as the place-specific code generation unit 1007 and the place-specific code storage unit 1008 in the first embodiment.

The encryption processing sub-unit 3033 decrypts, with use of the place-specific code PCODE stored in the place-specific code storage sub-unit 3032, encrypted data that is information about the house of a client, the encrypted data being stored in the cleaning information storage unit 304. Also, the encryption processing sub-unit 3033 encrypts the data that is the information about the house of the client, the encrypted data being stored in the cleaning information storage unit 304.

The cleaning information storage unit 304 stores information that is used to clean the house of the client. Assume here as one example that the client lives in an apartment. The stored information may include information indicating a map and route from the present location of the cleaning robot 3 to the entrance to the apartment building where the client lives, information indicating a map and route from the entrance to the apartment building to the entrance to the room of the client, the room layout of the apartment where the client lives, the family structure of the client, a time when the client is present in his/her home, part of the rooms of the client that is particularly dirty, and the images of the rooms of the client.

Here, the information indicating the map and route from the present location of the cleaning robot 3 to the entrance to the apartment building where the client lives is plain text data, which is not encrypted.

Also, the information indicating the map and route from the entrance to the apartment building to the entrance to the room of the client is encrypted with an encryption key that can be obtained from an image of the entrance to the apartment building.

Furthermore, the information indicating the room layout of the apartment where the client lives, the family structure of the client, a time when the client is present in his/her home, part of the house of the client that is particularly dirty, and images in the house of the client is encrypted with an encryption key that can be obtained from a picture of the entrance to the room of the client.

The route planning unit 305 estimates the present location using the map information and the routing information that are stored in the cleaning information storage unit 304, and sensing information obtained by the sensing unit 302. Then, the route planning unit 305 plans a route to the destination to give instructions to the autonomous move control unit 306, so that the cleaning robot 3 can travel along the route to the destination autonomously.

Since the main task of the present embodiment is cleaning, the route planning unit 305 may generate a route to move the floor of all rooms of the client.

The method for generating such routes is described in Non-Patent Document 2.

The autonomous move control unit 306 operates the transport unit 307, based on instructions from the route planning unit 305.

The transport unit 307 includes an engine, a tire, and so on, and causes the cleaning robot 3 to actually move.

The suction control unit 308 controls the suction power of the suction unit 309, based on the information of the house of a client, which is stored in the cleaning information storage unit 304. For example, the suction control unit 308 controls the suction unit 309 by increasing the suction power when cleaning particularly dirty parts, and by decreasing the suction power to reduce the noise when cleaning a room where a baby is sleeping.

The suction unit 309 sucks in dust and the like based on instructions from the suction control unit 308.

3.2. Operations of Cleaning Robot 3

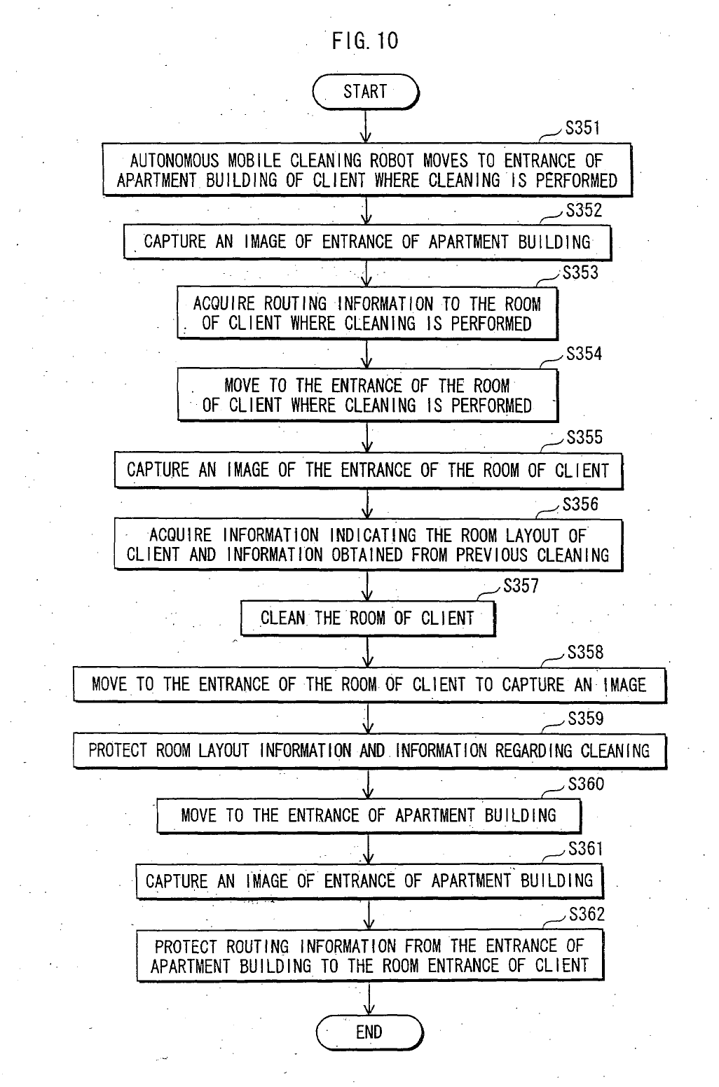

The following describes the cleaning robot 3 that has the above-described structure, with reference to the flow chart of FIG. 10.

First, based on the information indicating a map and route from the present location to the entrance of an apartment building, which is stored in the cleaning information storage unit 304, the route planning unit 305 calculates a travel route from the present location to the entrance to the apartment building where a client lives. Then, based on the result of the calculation, the route planning unit 305 gives instructions to the autonomous move control unit 306 to travel to the entrance of the apartment building where the client lives.

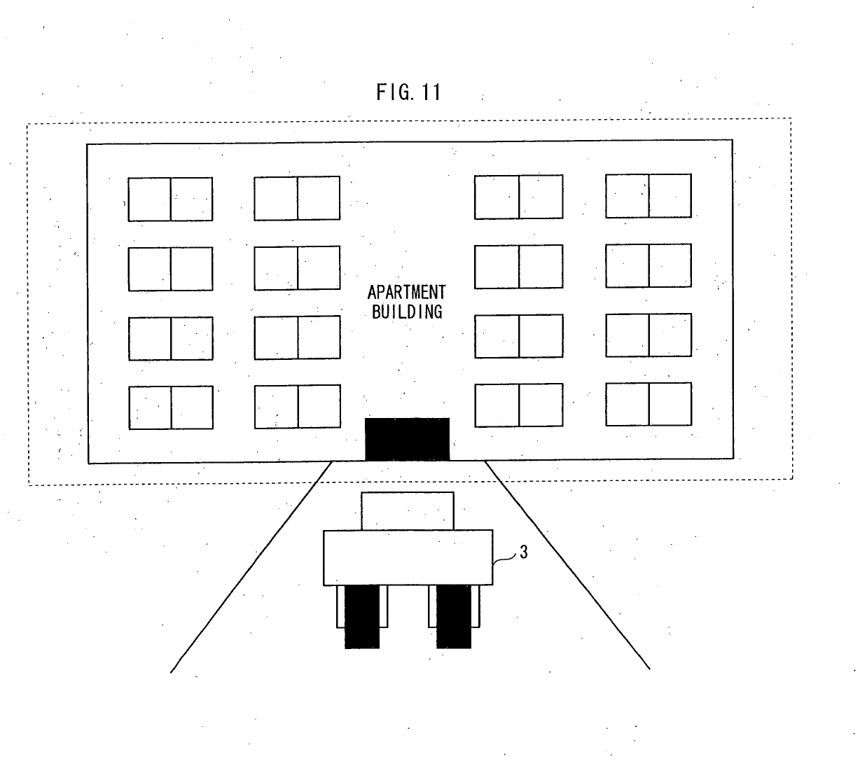

The autonomous move control unit 306 controls the transport unit 307 based on the instructions. As a result, the cleaning robot 3 travels to the entrance of the apartment building of the client, as shown in FIG. 11 (step S351).

At the entrance, the camera unit 301 captures an image of the entrance of the apartment building where the client lives. Then, the camera unit 301 outputs the image data PIC regarding the captured image to the information processing unit 303 (step S352).

The place-specific code generation sub-unit 3031 in the information processing unit 303 generates an encryption key using the image data PIC received from the camera unit 301, and outputs the encryption key to the encryption processing sub-unit 3033. Then, the encryption processing sub-unit 3033 decrypts information indicating a map and route from the apartment entrance, to the entrance to the room of the client, the information being encrypted and stored in the cleaning information storage unit 304 (step S353).

Next, based on the information indicating the map and route from the apartment entrance to the entrance to the room of the client, which is stored in the cleaning information storage unit 304, the route planning unit 305 calculates a travel route to the entrance to the room of the client.

Then, based on the result of the calculation, the route planning unit 305 gives an instruction to the autonomous move control unit 306 to move from the apartment entrance to the room entrance of the client.

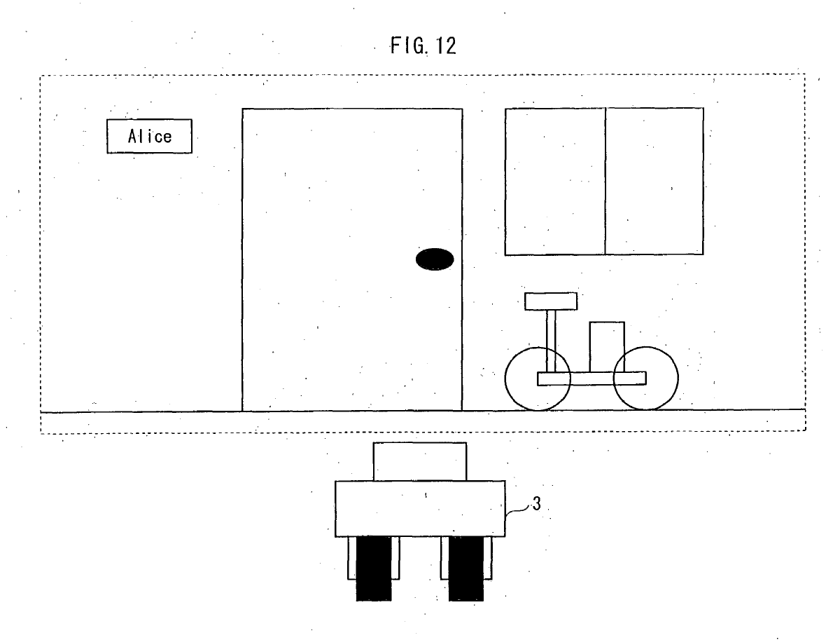

The autonomous move control unit 306 controls the transport unit 307 based on the instruction. As a result, the cleaning robot 3 moves to the room entrance of the client as shown in FIG. 12 (step S354).

At the room entrance, the camera unit 301 captures an image of the room entrance of the client. Then, the camera unit 301 outputs image data PIC that is data of the image to the information processing unit 303 (step S355).

The place-specific code generation sub-unit 3031 of the information processing unit 303 generates an encryption key using the image data PIC.

Then, the encryption processing sub-unit 3033 decrypts, by using the encryption key, information that is encrypted and stored in the cleaning information storage unit 304. The information includes, for example, the room layout of the client, the family structure of the client, the time when the client is present in his/her home, the part of the room of the client that is particularly dirty, and the images of the rooms of the client (step S356).

The route planning unit 305 of the cleaning robot 3 calculates a travel route to clean the rooms based on the obtained information indicating the room layout of the client. Then, the route planning unit 305 requests the autonomous move control unit 306 to move along the calculated travel route.

The autonomous move control unit 306 controls the transport unit 307 based on the request. As a result, the cleaning robot 3 moves along the travel route to clean the rooms.

While moving along the route, the suction control unit 308 controls the suction unit 309 based on the obtained information, such as the room layout of the client, the family structure of the client, the time when the client is present in his/her home, the part of the room of the client that is particularly dirty, and the images of the rooms of the client. Specifically, the suction control unit 308 controls the suction unit 309 by increasing the suction power when cleaning particularly dirty parts, and by decreasing the suction power to reduce the noise when cleaning a room where a baby is sleeping (step S357).

After the cleaning of the rooms of the client has been completed, the route planning unit 305 calculates a travel route to the room entrance of the client based on the room layout information of the client. Then, based on the result of the calculation, the route planning unit 305 requests the autonomous move control unit 306 to move to the room entrance of the client.

The autonomous move control unit 306 controls the transport unit 307 so as to cause the cleaning robot 3 to move to the room entrance of the client.

Here, the camera unit 301 captures an image of the room entrance of the client in order to send the image data of the image to the place-specific code generation sub-unit 3031 (step S358).

The place-specific code generation sub-unit 3031 generates an encryption key that corresponds to the image data of the room entrance of the client, which is received from the camera unit 301. Then, the place-specific code generation sub-unit 3031 outputs the encryption key to the encryption processing sub-unit 3033.

The encryption processing sub-unit 3033 encrypts information regarding the apartment of the client using the encryption key received from the place-specific code generation sub-unit 3031, and stores the information in the cleaning information storage unit 304 (step S359).

The route planning unit 305 calculates a travel route to the entrance of the apartment building of the client, based on information indicating a map and route from the present location (room entrance of the client) to the entrance of the apartment building, which is stored in the cleaning information storage unit 304. Then, based on the result of the calculation, the route planning unit 305 requests the autonomous move control unit 306 to move to the entrance of the apartment building of the client.

The autonomous move control unit 306 controls the transport unit 307 to cause the cleaning robot 3 to move to the entrance of the apartment building of the client. As a result, the cleaning robot 3 moves to the entrance to the apartment building of the client (step S360).

The camera unit 301 captures an image of the entrance of the apartment building of the client, in order to send the image data according to the image of the entrance to the apartment building where the client lives, to the place-specific code generation sub-unit 3031 (step S361).

Upon receiving the image data of the apartment entrance, the place-specific code generation sub-unit 3031 generates an encryption key that corresponds to the image data of the apartment entrance.

Then, the encryption processing sub-unit 3033 encrypts information indicating a map and route from the entrance of the room of the apartment where the client lives to the entrance of the apartment building. Then, the encryption processing sub-unit 3033 stores the encrypted information in the cleaning information storage unit 304 to complete the processing (step S362).

### 4. Modifications

Although the present invention has been fully described by way of examples with reference to the accompanying diagrams, it is to be noted that various changes and modifications will be apparent to those skilled in the art. Therefore, unless such changes and modifications depart from the scope of the present invention, they should be construed as being included therein.

(1) In the above-described embodiments, there are no descriptions of processing to match (i) a place in which the information processing apparatus 1 encrypts the plaintext data DDATA to generate the encrypted data EDATA with (ii) a place in which the information processing apparatus 1 attempts to decrypt the encrypted data EDATA.

However, for example, the information processing apparatus 1 may store part of a scenic image, and, based on the part of the image, the position of the information processing apparatus 1 and the direction of the camera module may be adjusted.

The information processing apparatus 1 associates sub image data SUBPIC, which is part of the place-specific code PCODE, with the encrypted data EDATA, in order to store the sub image data SUBPIC in the encryption data storage unit 1010. The sub image data SUBPIC may be, for example, a combination of three parts of the image of the image data PIC, which are the upper left corner, upper right corner, and the bottom left corner.

When decrypting the encrypted data EDATA, the image data acquisition unit 1004 may extract the three parts of the image from the sub image data SUBPIC. Then, by capturing another scenic image and the like, the image data acquisition unit 1004 may acquire new image data PIC. Then, the position of the information processing apparatus 1 and the direction of the camera module may be adjusted in such that combination data matches with the sub image data SUBPIC. The combination data is a combination of three parts of the image of the new image data PIC which are the upper left corner, upper right corner, and the bottom left corner.

As described above, by using the sub image data SUBPIC, the image data acquisition unit 1004 can easily judge what type of image data PIC to acquire. Accordingly, the image data acquisition unit 1004 can accurately judge the image data PIC that needs to be acquired, thereby increasing the ratio of the information processing apparatus 1 decrypting the encrypted data EDATA accurately.

Also, it is possible to mark the position where the image is captured.

After arriving in the vicinity of a destination by traveling autonomously, the cleaning robot recognizes the mark provided in the destination using an image sensor, and moves to the marked position.

Furthermore, the information processing apparatus 1 may include a GPS device and an electronic compass. Then, with use of GPS information acquired by the GPS device, and with azimuth information acquired by the electronic compass, the information processing apparatus 1 may match a place where the encrypted data EDATA has been generated with a place where the encrypted data EDATA is attempted to be decrypted.

Specifically, in the place where the encrypted data EDATA has been generated, the information processing apparatus 1 acquires the GPS information using the GPS device, and also acquires the azimuth information using the electronic compass. Then, the information processing apparatus 1 stores each piece of the acquired information. After that, in the case of traveling to the place where the encrypted data EDATA has been generated, the information processing apparatus 1 can travel to the place accurately, using the stored GPS information and azimuth information.

(2) The image data acquisition unit 1004 in the above-described embodiment is connected to a mobile camera module, and acquires the image data PIC therefrom. Then, when decrypting the encrypted data EDATA, the place-specific code generation unit 1007 generates a decryption key using the image data PIC of an image captured by the mobile camera module. Here, assume that the encryption processing unit 1009 has attempted to decrypt the encrypted data EDATA using the generated decryption key, but has failed to decrypt the encrypted data EDATA. In this case, the image data acquisition unit 1004 may slightly move the image capturing direction of the mobile camera module to cause the mobile camera module to capture another image to acquire new image data PIC. Then the place-specific code generation unit 1007 generates a new decryption key using the new image data PIC. Then, the encryption processing unit 1009 attempts to decrypt the encrypted data EDATA using the new decryption key. The above-described sequence of operations is repeated until the encryption processing unit 1009 succeeds in decrypting the encrypted data EDATA, or repeated for a predetermined number of times.

With the above-described structure, even though the acquired image data PIC is slightly different from the image data PIC that is needed to be acquired because of a deviation of the image capturing direction of the mobile camera module, the place-specific code generation unit 1007 can acquire the image data PIC from which a correct decryption key can be generated. Therefore, it is possible to increase the ratio of successful decryption of the encrypted data EDATA by allowing slight differences in conditions such as the deviation of the image capturing direction of a camera.

Note that the display unit 1003 may show a user the plaintext data DDATA to warn that the decryption of data has not been successful. Based on the warning, the user can take countermeasures against the decryption failure.

For example, the countermeasure may include a change of the direction of the camera module and a change of the position of the information processing apparatus.

(3) The encryption processing unit 1009 attempts to decrypt the encrypted data EDATA using the place-specific code PCODE. If the decryption fails, a modified place-specific code MPCODE, which is a code generated from a place-specific code PCODE being modified by several bits, may be used to decrypt the encrypted data EDATA.

With the above-described structure, even in a case of erroneous generation of the place-specific code PCODE, the ratio of obtaining a correct decryption key can be increased.

Note that the modified place-specific code MPCODE is only the code generated from a place-specific code PCODE being modified by several bits. Therefore, if a place-specific code PCODE that is completely different from a code used for encryption is generated, a modified place-specific code MPCODE generated based on the complete different place-specific code PCODE cannot be used to decrypt the encrypted data EDATA.

(4) A Method for generating the place-specific code PCODE from the image data PIC is not limited to the method described in the present embodiments. For example, after one or more objects shown in the image data PIC have been recognized, the characters of the one or more objects, such as the shapes, colors, and sizes, may be used for coding the data. This can be achieved with use of an edge extraction technique in image processing, the focal length of a camera, and so on. With the above-described structure, for example, even in a case that certain plaintext data DDATA was encrypted based on the image data PIC of a room, and then the room has been redecorated and the furniture of the room has been rearranged due to the redecoration of the room, the same place-specific code PCODE can be generated since objects in the image data PIC is recognized.

(5) The image data acquisition unit 1004 determines the validity of the image data PIC acquired from the camera module. If the image data acquisition unit 1004 determines that the image data PIC is invalid, the encryption processing performed by the encryption processing unit 1009 may be terminated.

For example, in order to detect a fraudulent act in which a picture is placed in front of the camera module that is used to capture a scenic image, the image data acquisition unit 1004 acquires a plurality of pieces of image data PIC, either in succession or at various times. Then, if the plurality of pieces of acquired image data PIC are all identical, the image data acquisition unit 1004 determines that a fraudulent act as described above is being committed since the sight in the picture has not changed at all.

Generally, a scenic image changes due to the change of a sunlight angle as time advances. Therefore, if the scenery in front of the camera module does not change at all, the fraudulent act as described above is assumed to be being committed.

Also, in the case that a picture is placed in front of the camera module, it is acceptable for the information processing apparatus 1 to have a function to move the picture away from the camera module by blowing air and such. The information processing apparatus 1 captures scenic images in succession while blowing air. In the case that there are significant differences among the plurality of captured scenic images, the information processing apparatus 1 may determine that the fraudulent act is being committed, considering that the picture is fluttering and the like.

(6) The information processing apparatus 1 may measure the elapsed time since the encrypted data EDATA was decrypted, and then may inform a user when the time has exceeded more than a certain length of time. The above-described structure can encourage a user to encrypt the plaintext data DDATA, and can further prevent confidential data from leaking.

(7) The place-specific code generation unit 1007 selects one method between the code generation method C1 and the code generation method C2 based on the environmental information SI that indicates luminance intensity measured by a lux meter. However, it is not limited to such.

The environmental information SI is not limited to luminance intensity. Any type of information is acceptable as long as the information is a criterion that can be used to select the most appropriate code generation method from among a plurality of code generation methods.

Also, the code generation methods are not limited to the methods described in the first embodiment.

For example, the following code generation method can be considered.

First, the image data PIC is divided into twelve parts in lengthwise, and also twelve parts in widthwise, whereby 144 pieces of small regional image data can be obtained. Here, each of the pixels that constitute the regional image data is represented by three values: R value (red), G value (green), and B value (blue). Also, in each of the pixels that constitute one piece of regional image data, a color having the maximum value (R value, G value, B value) is obtained among R value, G value, and B value.

Next, among the obtained colors (R values, G values, and B values), the color (R value, G value, B value) that has the largest number of pixels in which the value of the color is maximum, is set to be the representative color of the regional image data, and the representative color is set to be the characteristic quantity. As for the other pieces of the regional data, a representative color as characteristic quantity is obtained in the same manner as described above.

Then, if the representative color of the upper left regional image data that constitutes the image data PIC is R (red), the least significant bit of the place-specific code is set to be 0. If the representative color of the regional image data is either G (green) or B (blue), the least significant bit of the place-specific code PCODE is set to be 1.

Subsequently, while sequentially shifting from one piece of the regional data to another to the right, the higher order bits of the place-specific code PCODE are coded as well in the same manner as described above. In this way, the place-specific code PCODE is generated from the image data PIC.

When the representative colors of pieces of the regional image data are used for coding as described above, even though there are small changes in a certain region in the captured image data (image blurring, noise) between the time of encryption and decryption, for example, as long as the dominance degree of color does not change, the same place-specific code PCODE as the previously generated code can be generated. The above-described method can allow slight changes (image blurring, noise) that may occur when capturing images.

(8) In the third embodiment, the robot is a cleaning robot. However, the robot is not limited to cleaning use. For example, the robot may be an autonomous mobile robot that provides service which has a possibility of visiting the house of a client a plurality of times, and the service may be for other use than cleaning. For example, the robot may be a delivery robot that delivers pizza, sushi, or the like, a massage robot, a robot that is a conversation partner of a: solitary elderly person, a sales robot, or a robot that carries grocery bags from a supermarket to the house of a client. Also, the robot may be a robot pet such as a dog-shaped robot or a cat-shaped robot.

(9) In the second embodiment, regarding the place-specific code PCODE and the second place-specific code PCODE2, if the ratio of the number of matching bit values in the same bit position between the place-specific code PCODE and the second place-specific code is equal to or higher than a predetermined ratio, confidential data can be accessed. However, it is not limited to such. Depending on the ratio of the number of matching bit values in the same bit position, the strictness of access restriction, a range of data accessible, the number of pieces of data accessible, a kind of data accessible, and the like can be changed.

For example, if the ratio of the number of matching bit values between the place-specific code PCODE and the second place-specific code PCODE2 is equal to or higher than 90%, the access to all confidential data may be permitted. If the ratio of the number of matching values there between is 80% or more and less than 90%, certain part of confidential data may be accessed.

The following describes the case in which the above-described characteristics are adopted to the above-described cleaning robot, with specific examples.

A cleaning robot according to the present modification has a communication function, has an intelligent conversation with a client, learns from the content of a previous conversation, and stores the learned information in the cleaning information storage unit 304.

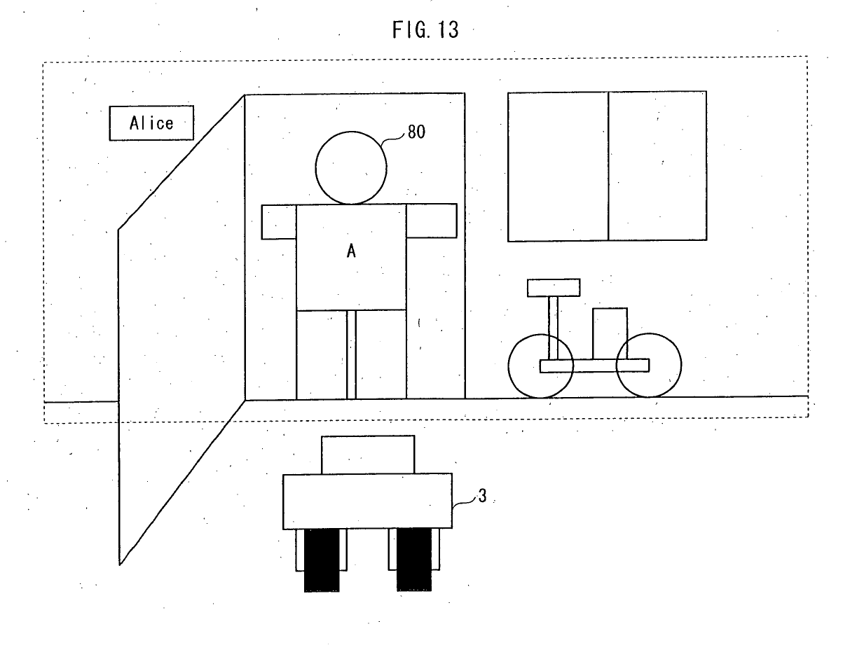

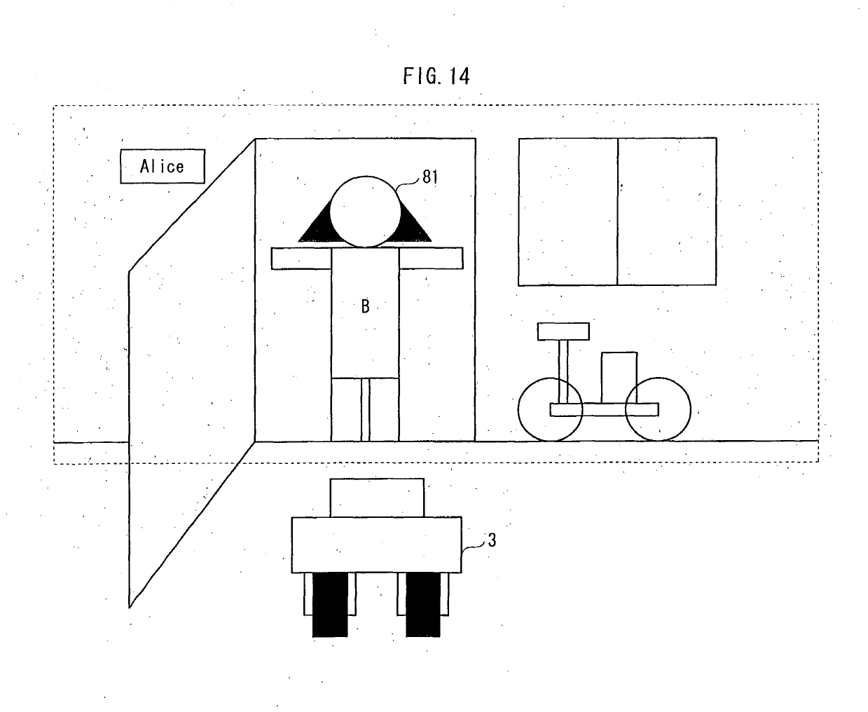

It is assumed here that, when the cleaning robot has previously visited the house of a client, a person 80 has answered the door. The cleaning robot learns by having a conversation with the person 80. Then, the cleaning robot stores the learned information in the cleaning information storage unit after encrypting the learned information with an encryption key that is generated from a picture (see FIG. 13) that shows the person 80.

Subsequently, assume that when the cleaning robot visits the house of the same client again after the previous visit, another person 81, who is different from the person 80, answers the door. In this case, when an image of the front door of the client's house is captured, the image is different from the previously captured image in a part of a person who answers the door. Assume here that the ratio of the number of matching bit values between the place-specific code that has previously been generated and a place-specific code that is subsequently generated is 60%.

It is also assumed that the access restriction is set in such that, if the ratio of the number of matching bit values between the place-specific code that has been previously generated and a place-specific code that is subsequently generated is in a range of 50% to 70% inclusive, the information regarding cleaning, such as the room layout of the house, can be obtained, but the learned information acquired from the content of the previous conversation with the person 80 cannot be obtained since the unprotection of the learned information is not performed.

In this case, if the ratio of the number of matching bit values is 60% as described above, the cleaning robot can obtain the information regarding cleaning such as the room layout of the house, but cannot obtain the learned information acquired from the content of the previous conversation with the person 80. Accordingly, the cleaning robot cannot use the learned information previously acquired from the person 80 for the person 81 with whom the robot is meeting at the present moment. Therefore, the possibility of the learned information regarding the person 80 being known by the person 81 can be eliminated. In other words, the privacy of the person 80 can be protected.

(10) When the cleaning robot 3 captures an image, the robot may detect, in the image, an object that changes in accordance with time and seasons. Then, when capturing an image at the same place as the previous time again, the cleaning robot 3 may prevent the presence or absence of the object from affecting the generation of the place-specific code based on the information regarding time and seasons.

The following describes one example of the above-described scene using a cleaning robot.

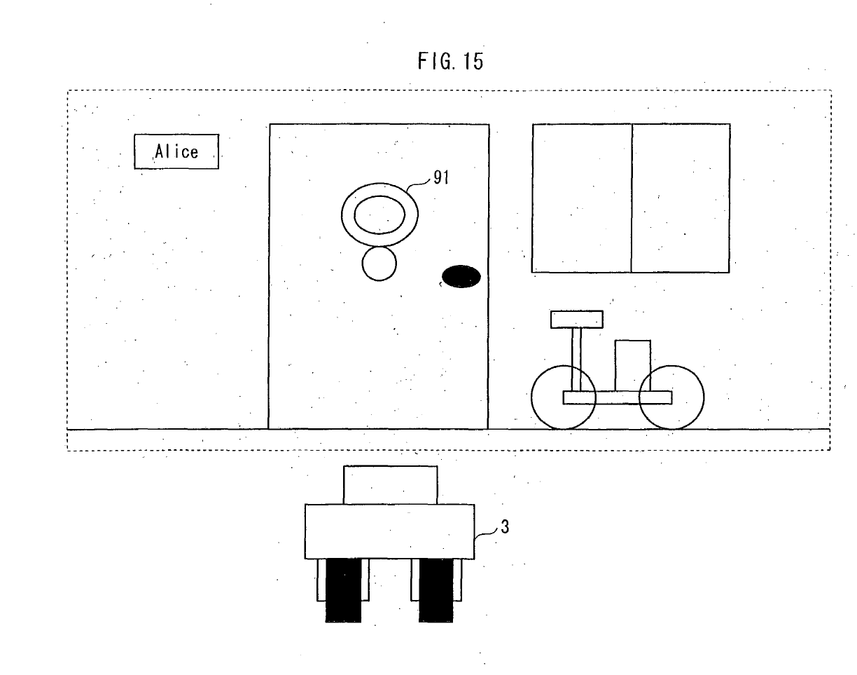

First, assume that a cleaning robot has captured an image when the robot has visited the house of a client in a New Year period, and, as shown in FIG. 15; the image is of a New Year decoration 91. The cleaning robot judges that the New Year decoration 91 shown in the image is only for a New Year period, and the next visit is highly unlikely to be the New Year period, so that the New Year decoration 91 will have been removed by the next visit.

Then, the cleaning robot performs image processing so as to delete the New Year decoration 91 from the image data of the image. Then, the cleaning robot generates an encryption key for the image data on which the image processing has been performed in order to protect the data.

Assume that the cleaning robot visits the house of the same client again a few months after the previous visit.

Assume that when the cleaning robot captures an image in the house of the client, the captured image does not show the New Year decoration 91 as shown in FIG. 13.

The cleaning robot generates an encryption key for the image data of the above captured image that is captured a few months after the New Year. With the above-described process, it is assumed that the encryption key which is previously generated matches with the encryption key which is subsequently generated. The cleaning robot unprotects the data using the subsequently generated key. In this way, the cleaning robot can adjust to the predictable changes of images.

Note that in an encryption scheme used by the cleaning robot, data that is encrypted using an encryption key can be decrypted using the same encryption key used for the encryption.

The method described below may also be used.

First, assume that a cleaning robot has captured an image when the robot has visited the house of a client a few months before a New Year period, and, as shown in FIG. 12, the image without the New Year decoration 91 is captured. The cleaning robot generates an encryption key from the image data of the captured image in order to protect confidential data. Next, assume that when the cleaning robot visits the house of the same client again in the New Year period, which is a few months after the previous visit, a captured image shows the New Year decoration 91 as shown in FIG. 15. Here, the New Year decoration 91 shown in the image is only for a New Year period, and the previous visit was not in a New Year Period. Therefore, the cleaning robot judges that the New Year decoration 91 has been newly added. The cleaning robot removes the New Year decoration 91 from the image data of the captured image by performing image processing. Then, the cleaning robot generates an encryption key from image data on which the image processing has been performed, and unprotects confidential data using the encryption key. In this way, the cleaning robot can adjust to the predictable changes of images.

(11) In the above-described embodiment, the place-specific code generation unit 1007 generates the place-specific code PCODE from the image data PIC of a scenic image captured by a camera module. However, it is not limited to such. The place-specific code generation unit 1007 may generate the place-specific code PCODE from information other than the image data PIC as long as the information can generate a code specific to a place.

For example, assume that the image data acquisition unit 1004 is connected to the three-dimensional scanner, a distance sensor, or the like, and acquires three-dimensional modeling data from the three-dimensional scanner, the distance sensor, or the like.

The three-dimensional scanner and the distance sensor are well known techniques. Therefore the explanation thereof is omitted (See http://www.sunagaimpulse.com/Syozai/Lasersite/RIRGL/LaserRIEGLmain.html#3D).

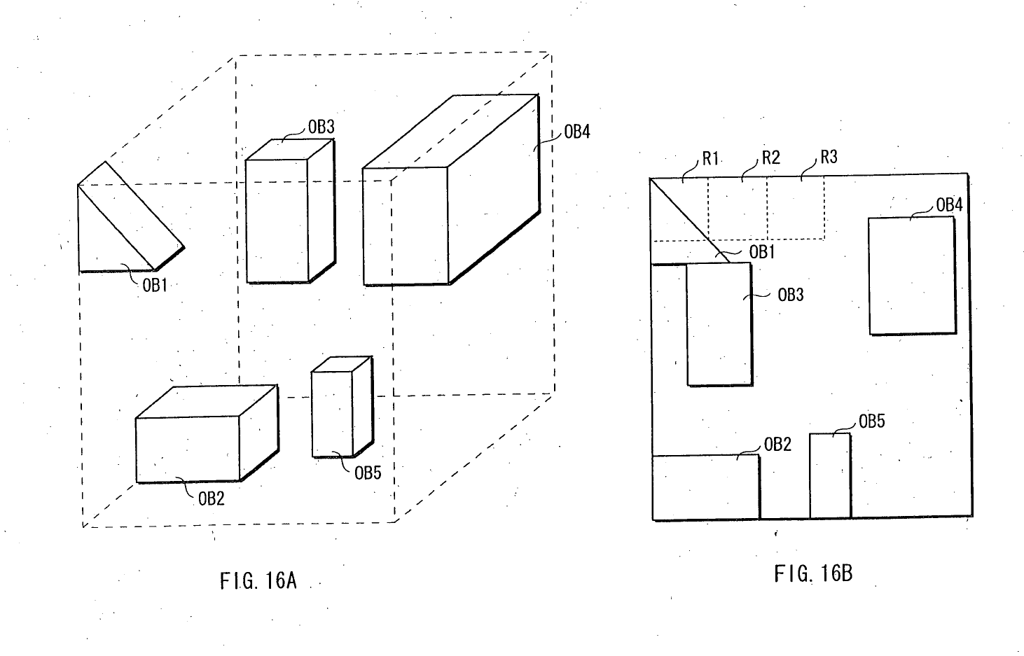

Assume that the image data acquisition unit 1004 has acquired three-dimensional modeling data MD indicating a three-dimensional model shown in FIG. 16A. The place-specific code generation unit 1007 generates diagrams of the three-dimensional model, such as a front view, a side view, and a top view, based on the three-dimensional modeling data MD. For the above-described diagrams, the place-specific code generation unit 1007 generates a place-specific code using either one of the code generation method C1 or the code generation method C2.

Assume that FIG. 16B is the front view of the three-dimensional model. Assume also that the place-specific code generation unit 1007 uses the code generation method C1. Here, the code generation method C1 has already been described, and descriptions thereof are thus simplified.

The place-specific code generation unit 1007 divides the front view into regions having a predetermined size. Hereinafter, the region in the upper left corner of the front view is represented as R1, and the region positioned to the immediate right of R1 is represented R2 . . . . Since the edge element of the region R1 is in the diagonal direction connecting the upper left and the bottom right, the place-specific code generation unit 1007 allocates code 10 to the region R1.

Codes are allocated to the region R2 . . . and the rest of the regions in the same manner. Also for the side view and top view, coding is performed in the same manner using the code generation method C1.

Data that has been obtained as a result of coding is connected to generate, for example, a place-specific code of 128 bits. Data to be connected may be generated using any one of a front view, a side view, and a top view. The data may also be generated using a plurality of views. For example, the upper 64 bits may be generated using a top view, and the lower 64 bits may be generated using a side view.

Also, in stead of generating a view from a three-dimensional model, a code can be allocated to an object that is included in the three-dimensional model to generate a place-specific code.

For example, the place-specific code may be generated in such that if the volume of the object included in the three-dimensional model is 0 or more and less than 5 m³, a code 00 is allocated to the object. If the volume thereof is 5 m³ or more and less than 10 m³, a code 01 is allocated, if the volume thereof is 10 m³ or more and less than 15 m³, a code 10 is allocated, and if the volume thereof is 15 m³ or more, a code 11 is allocated.

FIG. 16A has only five objects including OB1-OB5, in order to simplify the diagram. However, 64 or more pieces of objects can be included in the three-dimensional model, depending on a target image. For example, assume that a three-dimensional model obtained by the image data acquisition unit 1004 includes 64 pieces of objects including OB1-OB64.

After calculating each volume of the OB1-OB64 respectively, the place-specific code generation unit 1007 allocates each corresponding code to OB1-OB64 respectively based on the above-described principle.

Then, codes allocated to OB1-OB64 are connected to generate the place-specific data of 128 bits.

Also, information for allocating codes is not only limited to volume as described above. In the information obtained by three-dimensional scanning, any type of information is acceptable as long as a code can be allocated thereto. For example, the information may indicate (i) any one of the width, depth, and height of an object, (ii) a total value of the width, depth, and height of the object, (iii) a combination of the three, or the like.

Furthermore, the following may be used for coding: the spatial position coordinate at the top of an object, the tilt of an edge, grayscale edge in color information.

(12) The cleaning robot and the information processing apparatus 1 may be set in such that only when a specific route has been followed, a place (destination) that is subject to a place bind is identified.

The following describes an example of a case of setting the robot in such that, unless the robot follows a place A, a place B, a place C, and a destination in the stated order, a key cannot be generated.

Assume that the cleaning robot stores encrypted data KIA described below.

KIA=Enc (Ka, PlaceB∥Enc (Kb, Place C∥Enc (Kc, PlaceGoal)))

Here, each of the Ka, Kb, and Kc represents a place-specific code for the place A, the place B, and the destination respectively. Each of the Place B, Place C, and PlaceGoal is a piece of information indicating a place, and includes latitude and longitude that indicate the position of the Place B, Place C and the destination respectively. A symbol X Y represents a state of data X and data Y being connected to each other.

A symbol Enc (X, Y) represents plain text Y being encrypted with a key X. Also, as for an encryption scheme, a scheme that uses a same key for encryption and decryption is adopted. In other words, Enc (X, Y) is decrypted with the key X to obtain the plain text Y.

The cleaning robot first goes to the place A to generate the place-specific code Ka of the place A. Then, the KIA is decrypted using the Ka to obtain the Place B, and KIB=Enc (Kb, PlaceC∥Enc (Kc, PlaceGoal)).

Then, the cleaning robot moves to the place B which is a position indicated by the Place B. The cleaning robot generates the place-specific code Kb in the place B to decrypt the KIB using the Kb, thereby obtaining the Place C, and KIC=Enc (Kc, PlaceGoal). Then, the cleaning robot moves to the place C indicated by the Place C. Subsequently, the cleaning robot generates the place-specific code Kc in the place C, and decrypts the KIC using the Kc, thereby obtaining the PlaceGoal.

Then, the cleaning robot moves to the destination indicated by the PlaceGoal to perform processing for a place-bind, which can be seen in the above-described embodiment.

By performing the above-described processing, the cleaning robot can identify a destination only when the robot moves the place A, the place B, and the place C in the stated order.

For example, the cleaning robot can be set to clean the place A, the place B, the place C, and the destination in the stated order.

(13) The place-specific data is not always generated based on a still image or three-dimensional data. For example, the place-specific data may be generated based on moving image data. The moving image data may be recognized as a plurality of pieces of image data, and be coded in the similar manner as described above. The moving image data may also be coded using characteristic data, which is data of motion differences. The characteristic data may also be infrared image data.

Also, the place-specific data may be generated based on audio data specific to the place (noise, a cry of an animal, for example), luminance intensity data (brightness), accurate azimuth data, or the like.

Furthermore, in the case of mobile devices, a place-specific data may be a value that is obtained by a route or distance to a destination being encrypted. The same applies to the autonomous mobile robot.

(14) The place-specific code may be generated in such that, a code generated based on an image or three-dimensional data is combined with a code generated according to the above chapter (13). Specifically, for example, when the autonomous mobile robot visits an apartment room, the robot may generate a first code based on the image data of the room, and may further generate a second code based on distance data from an elevator or entrance of the apartment building to the room, thereby merging the first code and the second code to generate the place-specific code. This makes it possible to identify each of the apartment rooms uniquely even though all the apartment rooms are similar in appearance and character.

(15) The place-specific code is not always generated from one piece of image data using one coding method. For example, a plurality of partial codes may be generated from one piece of image data using a plurality of coding methods, and then the plurality of partial codes may be combined with each other to make one piece of place-specific code.

(16) Each of the above-described devices is a computer system comprising a microprocessor, a ROM, a RAM, a hard disk unit, a display unit, a keyboard, a mouse and the like. A computer program is stored either in the RAM or in the hard disk unit. Each of the devices achieves its functions based on the operations of the microprocessor in accordance with the computer program. Here, the computer program is a combination of a plurality of instruction codes that give instructions to a computer, so that the computer can perform predetermined functions.

(17) All or part of the components constituting each of the above described devices may be one piece of system LSI (Large Scale Integration). A system LSI is a super multifunctional LSI manufactured by integrating multiple structural units onto a single chip. Specifically, it is a computer system including a microprocessor, ROM, RAM and the like. The RAM stores the computer program. The system LSI achieves its functions when the microprocessor operates in accordance with the computer program.

(18) Part or all of the components of the above described devices may be structured as an IC card or a stand-alone module that is removable from each of the devices. Each of the IC card and the module is a computer system including a microprocessor, ROM, RAM and the like. Each of the IC card and the module may also include the above super multifunctional LSI. The IC card and the module achieve their functions as the microprocessor operates in accordance with the computer program. The IC card and module may be tamper resistant.

(19). The present invention may be the methods shown above. Also, the present invention may be computer programs for causing computers to realize the methods, or may be digital signals representing the computer programs.

(20) Also, the present invention may be a computer-readable recording medium on which the computer programs or the digital signals are recorded such as a flexible disk, a hard disk, a CD-ROM, an MO, a DVD, a DVD-ROM, a DVD-RAM, a BD (Blu-ray Disc), and a semiconductor memory. The present invention may be the digital signals which are recorded on the above described recording media.

(21) Also, the present invention may be the computer programs or digital signals which are transmitted via an electronic communications circuit, a wireless or fixed-line communications circuit, a network acting as the internet, a data broadcast and the like.

(22) Also, the present invention may be a computer system including a microprocessor and a memory, whereby the memory stores the computer program, and the microprocessor operates in accordance with the computer program.

(23) Also, the present invention may be carried out by another independent computer system by transferring the program or the digital signals which have been recorded on the recording media, or by transferring the program or the digital signals via the network and the like.

(24) The above embodiments and the above modifications may be combined.

Although the present invention has been fully described by way of examples with reference to the accompanying diagrams, it is to be noted that various changes and modifications will be apparent to those skilled in the art. Therefore, unless such changes and modifications depart from the scope of the present invention, they should be construed as being included therein.

What is claimed is:

1. A confidential data protection apparatus that restricts use of confidential data to a particular place, the confidential data protection apparatus comprising:
a storage unit that stores the confidential data;
an image capturing unit operable to capture an image at a place to generate image data;
a generation unit operable to generate a place-specific code with use of the generated image data, the place-specific code indicating a characteristic specific to the place at which the image capturing was performed; and
a control unit operable to control whether or not to permit use of the confidential data, based on the place-specific code.

2. The confidential data protection apparatus of claim 1, wherein
the generation unit includes:
a detection sub-unit operable to divide the image into smaller pieces of image, and detect edges of picture objects shown therein;
a coding sub-unit operable to allocate a code to each of the edges that have been detected; and
a concatenating sub-unit operable to generate the place-specific code by concatenating each of the codes that have been allocated.

3. The confidential data protection apparatus of claim 1, wherein
the generation unit includes:
a detection sub-unit operable to divide the image into smaller pieces of image, and detect color information indicating dominant colors shown in the smaller pieces of image;
a coding sub-unit operable to allocate a code to each piece of the color information that is detected from a different one of the smaller pieces; and
a concatenating sub-unit operable to generate the place-specific code by concatenating the codes that have been allocated.

4. The confidential data protection apparatus of claim 1, wherein
the generation unit extracts information indicating at least one of (i) a shape of an object, (ii) a color of the object, and (iii) a size of the object that are shown in the generated image data, and generates the place-specific code using the information that has been extracted.

5. The confidential data protection apparatus of claim 4, wherein
the image capturing unit generates, as the image data, three-dimensional modeling data of the sight, and
the generation unit generates a plurality of plane images with use of the three-dimensional modeling data, and also generates the place-specific code from the plurality of plane images.

6. The confidential data protection apparatus of claim 1, wherein
the control unit encrypts the confidential data with use of the place-specific code.

7. The confidential data protection apparatus of claim 1, wherein
the control unit restricts access to the confidential data with use of the place-specific code as an authentication password.

8. The confidential data protection apparatus of claim 1, wherein
in a state that the confidential data is not permitted to be used, if a place-specific code indicating a characteristic specific to the particular place matches with the place-specific code indicating the characteristic specific to the place in which the image capturing has been performed, the control unit permits the confidential data to be used.

9. The confidential data protection apparatus of claim 8, wherein
the control unit changes, in accordance with a degree of consistency between (i) the place-specific code indicating the characteristic specific to the particular place and (ii) the place-specific code indicating the characteristic specific to the place in which the image capturing has been performed, an accessible range of content of the confidential data.

10. The confidential data protection apparatus of claim 8, wherein
if the place-specific code indicating the characteristic specific to the particular place does not match with the place-specific code indicating the characteristic specific to the place in which the image capturing has been performed, the control unit causes the image capturing unit to change an image capturing direction and capture an image.

11. The confidential data protection apparatus of claim 8, wherein
the image capturing unit stores partial image data that is part of the image data generated from the image captured in the particular place, and keeps capturing images by changing the image capturing direction until acquiring image data that includes data identical to the partial image data at the same place as the partial image data, and outputs the image data that includes the data identical to the partial image data.

12. The confidential data protection apparatus of claim 8, wherein
if the place-specific code indicating the characteristic specific to the particular place does not match with the place-specific code indicating the characteristic specific to the place in which the image capturing has been performed, the control unit interchanges one bit that is included in the place-specific code indicating the characteristic specific to the place in which the image capturing has been performed, and if the place-specific code that has the one bit interchanged matches with the place-specific code indicating the characteristic specific to the particular place, the confidential data is permitted to be used.

13. The confidential data protection apparatus of claim 8 including:
a fraud-detection unit operable to cause the image capturing unit to capture a plurality of images, and in a case that the plurality of images all match with each other, prevent the control unit from permitting the confidential data to be used.

14. The confidential data protection apparatus of claim 1, wherein
the generation unit includes:
a plurality of coding units, each of which operable to perform coding differently from the other coding units;
an environmental information acquisition unit operable to acquire environmental information;
a selecting unit operable to select one coding unit from among the plurality of coding units according to the environmental information, whereby the selected one coding unit generates the place-specific code with use of the generated image data.

15. The confidential data protection apparatus of claim 14, wherein
the environmental information acquisition unit acquires the environmental information that indicates luminance intensity.

16. An autonomous mobile robot that restricts use of confidential data to a particular place, the autonomous mobile robot comprising:
a storage unit that stores the confidential data including learned information;
an image capturing unit operable to capture an image at a place to generate image data;
a generation unit operable to generate a place-specific code with use of the generated image data, the place-specific code indicating a characteristic specific to the place at which the image capturing was performed; and
an autonomous move control unit operable to, when the confidential data is permitted to be used, perform an autonomous move control with use of the learned information.

17. The autonomous mobile robot of claim 16, wherein
the learned information is updated with use of information acquired by the robot moving autonomously.

18. The autonomous mobile robot of claim 16, wherein
the confidential data includes map information for a route control.

19. A confidential data protection method that restricts use of confidential data to a particular place, the confidential data protection method comprising:
an image capturing step for capturing an image at a place to generate image data;
a generation step for generating a place-specific code with use of the generated image data, the place-specific code indicating a characteristic specific to the place at which the image capturing was performed; and
a control step for controlling whether or not to permit use of the confidential data, based on the place-specific code.

20. A computer program used for a confidential data protection apparatus that restricts use of confidential data to a particular place, the computer program comprising:
an image capturing step for capturing an image at a place to generate image data;
a generation step for generating a place-specific code with use of the generated image data, the place-specific code indicating a characteristic specific to the place at which the image capturing has been performed; and
a control step for controlling whether or not to permit use of the confidential data, based on the place-specific code.

21. An integrated circuit that restricts use of confidential data to a particular place, the integrated circuit comprising:
a storage unit that stores the confidential data;
an image capturing unit operable to capture an image at a place to generate image data;
a generation unit operable to generate a place-specific code with use of the generated image data, the place-specific code indicating a characteristic specific to the place at which the image capturing was performed; and
a control unit operable to control whether or not to permit use of the confidential data, based on the place-specific code.
